(19) United States
(12) Patent Application Publication
(10) Pub. No.: US 2026/0289612 A1
(43) Pub. Date: Sep. 24, 2026

(54) SYSTEM

(71) Applicant: SoftBank Group Corp., Tokyo (JP)

(72) Inventor: Megumi KIMOTO, Tokyo (JP)

(73) Assignee: SoftBank Group Corp., Tokyo (JP)

(21) Appl. No.: 19/560,312

(22) Filed: Mar. 9, 2026

(30) Foreign Application Priority Data
Mar. 19, 2025 (JP) 2025-044915

(51) Int. Cl. G06Q 30/0241; G06N 3/0475; G06N 3/048

(52) U.S. Cl. CPC G06Q 30/0276; G06N 3/0475; G06N 3/048

(57) ABSTRACT

A system includes a processor, wherein the processor is configured to: receive information regarding a product for which advertisement placement is desired; generate a prompt based on the received information to instruct a generative artificial intelligence model to generate an advertisement message; and transmit the generated advertisement message to a user terminal so that a user can review and edit the advertisement message.

### CROSS-REFERENCE TO RELATED APPLICATION

This application is based on and claims priority under 35 USC 119 from Japanese Patent Application No. 2025-044915 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an: associated instruction sentence, encoding the prompt, and inputting the encoded prompt to a language model to generate a chatbot utterance responding to the user utterance.

Conventional techniques for creating online advertisements rely heavily on manual work by advertisers or specialized agencies. In particular, when an advertiser wishes to place an advertisement for a specific product, the advertiser must manually prepare advertising messages that are suitable for the product features, target audience, and advertising platform. This process requires copywriting skills and knowledge of advertising techniques, and therefore becomes a significant burden, especially for small and medium-sized business operators who do not possess such expertise or resources. Furthermore, even when generative artificial intelligence models are available, there is a problem that the advertiser must manually design prompts and repeatedly trial-and-error to obtain appropriate advertisement messages. Additionally, there is insufficient support for systematically analyzing the effectiveness of the generated advertisement messages and providing feedback that directly leads to monetization and increased advertisement submissions. As a result, there is a need for a system that can automatically generate advertisement messages from product information in a user-friendly manner, allow the user to easily review and edit the messages, and further support continuous improvement of advertising performance.

### SUMMARY

In order to solve the above-described problems, the present invention provides a system comprising a processor, wherein the processor is configured to receive information regarding a product for which advertisement placement is desired, generate a prompt based on the received information to instruct a generative artificial intelligence model to generate an advertisement message, and transmit the generated advertisement message to a user terminal so that a user can review and edit the advertisement message. The processor is further configured to provide a plurality of templates selectable by the user so that small and medium-sized business operators can easily use the system without requiring advanced copywriting skills or specialized knowledge of generative artificial intelligence. Moreover, the processor is configured to analyze an effectiveness of the generated advertisement message, for example based on performance metrics such as click-through rates and conversion rates, and to provide feedback for promoting monetization and an increase in advertisement submissions. By these means, the system according to the present invention enables efficient creation, refinement, and utilization of advertisement messages, thereby reducing the burden on advertisers and improving advertising outcomes.

The term “system” refers to an integrated whole including at least a processor and any associated hardware, software, communication interfaces, and storage necessary to perform the claimed functions.

The term “processor” refers to any hardware processing device or combination of devices, such as a CPU, GPU, microcontroller, ASIC, or FPGA, that executes instructions to perform the claimed operations.

The term “product for which advertisement placement is desired” refers to any good, service, application, content, or offering that an advertiser wishes to promote by displaying an advertisement through an advertising medium.

The term “information regarding a product for which advertisement placement is desired” refers to data describing the product, including but not limited to product name, features, benefits, specifications, price, usage examples, target customers, and any other attributes relevant to advertising.

The term “prompt” refers to a text or structured instruction generated by the processor and provided as input to a generative artificial intelligence model in order to cause the model to generate an advertisement message that reflects the received product information.

The term “generative artificial intelligence model” refers to a machine learning model, such as a large language model or other generative model, that is configured to generate new content, including text, based on input data such as prompts.

The term “advertisement message” refers to text content used for advertising, including but not limited to titles, descriptions, slogans, calls to action, and any other textual elements intended to promote the product.

The term “user terminal” refers to any device operated by a user, such as a personal computer, smartphone, tablet, or other communication terminal, that can send and receive data to and from the system.

The term “user” refers to a person or entity, including an advertiser or an operator on behalf of an advertiser, who uses the system through the user terminal to create, review, edit, or manage advertisement messages.

The term “templates” refers to predefined formats or patterns for advertisement messages, including but not limited to fixed or semi-fixed structures, phrase sets, and layout rules, which can be selected by the user to guide generation or editing of advertisement messages.

The term “small and medium-sized business operators” refers to business entities having a relatively small or medium scale in terms of employees, sales, or capital, and typically lacking specialized in-house advertising or technical resources.

The term “effectiveness of the generated advertisement message” refers to a performance characteristic of the advertisement message, including but not limited to click-through rate, conversion rate, impression count, engagement, or other measurable indicators of advertising performance.

The term “feedback for promoting monetization and an increase in advertisement submissions” refers to information or recommendations provided to the user based on analysis of advertisement effectiveness, such as suggested message modifications, targeting adjustments, budget recommendations, or other guidance intended to improve revenue and encourage the creation and submission of additional advertisements.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

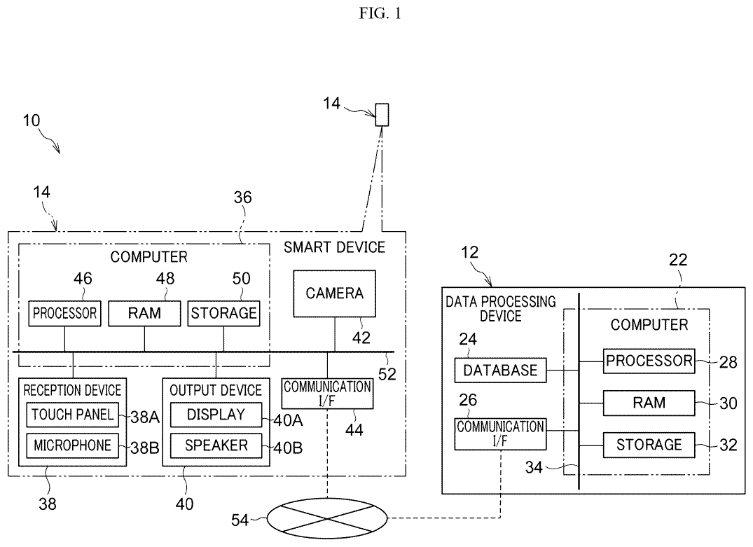

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

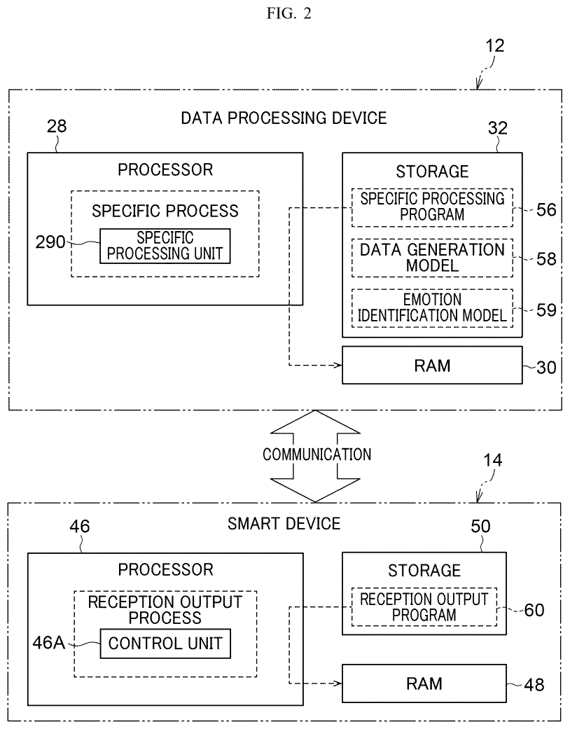

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented advertisement creation systems suffer from several technical limitations in how they process and generate text content. In many existing systems, a server merely relays user-entered product information to a generative model without performing sufficient structural validation, normalization, or prompt construction. As a result, unstructured or noisy input text often leads to unstable generation behavior, inconsistent output quality, and increased failure cases on the model side, which in turn requires repeated user interaction and manual correction. This lack of robust, machine-oriented preprocessing and structured prompt generation causes inefficient use of computing resources and degraded responsiveness of the overall system.

Furthermore, traditional systems frequently treat the communication with a generative model as a simple black-box call. Such systems do not maintain an internal representation that tightly associates user input data, prompt sentences, generated advertisement messages, and subsequent editing states. Without this association, the server cannot efficiently manage multiple message variants, cannot reliably restore or trace prior generation states, and cannot easily support interactive editing workflows on user terminals. This results in redundant storage operations, inefficient data retrieval, and increased latency when rendering complex management screens that must display multiple advertisement states and histories.

In addition, many known systems lack a structured mechanism by which a server dynamically selects and configures prompt structures based on advertisement format, medium type, target audience, or tone constraints. Instead, these systems often rely on fixed or manually authored prompts. Such static prompts limit the system's ability to adapt to different output length constraints, platform requirements, or user goals, and can lead to unnecessary expansion of the token space processed by the generative model. This increases computational overhead, network bandwidth usage, and response time on the server and model infrastructure.

Moreover, existing platforms typically do not integrate model output with quantitative performance feedback in a way that directly influences subsequent prompt design and template selection at the server level. While separate analytics tools may compute click-through rates or conversion rates, these metrics are rarely linked back into the generative logic in a programmatic fashion.

Consequently, the server cannot automatically refine selection conditions for sentence generation patterns or adjust generation parameters in response to measured effectiveness. This absence of a feedback-driven control loop limits the technical capability of the system to optimize model invocation patterns and prompt configurations over time.

Accordingly, there is a need for an improved computer-implemented system and server architecture that: (i) performs rigorous validation and normalization of user input to generate structured data suitable for machine processing; (ii) programmatically constructs and manages prompt sentences tailored to various advertisement formats and conditions; (iii) postprocesses and persistently associates generated messages, prompts, and states in a storage device in a way that supports efficient retrieval and interactive editing; and (iv) integrates performance feedback into the selection and refinement of sentence generation patterns. Such improvements address specific technical problems in data handling, request formation for generative AI models, and stateful management of generated content, thereby enhancing the reliability, efficiency, and scalability of computer-based advertisement generation and management systems.

The specific processing by the specific processing unit 290 of the data processing device 12 in Example 1 is realized by the following means.

The present invention provides a server comprising a processor and a storage device, the processor being configured to acquire, via a communication line from a user terminal, input data including attribute information relating to a product or service to be advertised, appeal information, and advertisement format information; validate and normalize the input data to generate preprocessed structured data; select, based on the structured data, at least one sentence generation pattern from among a plurality of predefined sentence generation patterns; automatically construct a prompt sentence suitable for input to a generative AI model by embedding the structured data into the selected sentence generation pattern; generate request data including the prompt sentence; transmit the request data to the generative AI model via an external interface; acquire an advertisement message candidate generated by the generative AI model on the basis of the prompt sentence; postprocess the advertisement message candidate to generate a plurality of advertisement messages that satisfy predetermined constraints; store, in the storage device, the plurality of advertisement messages in association with the corresponding prompt sentence and the input data together with unique identifiers and state information; and generate and transmit to the user terminal screen data of an advertisement management screen that presents the plurality of advertisement messages in individually editable regions and displays their processing states, and update the stored advertisement messages and state information based on editing results received from the user terminal. This enables a technical improvement in computer-based advertisement generation and management by optimizing data structures and prompt construction prior to model invocation, reducing inconsistent model behavior, ensuring efficient storage and retrieval of state-associated generated content, supporting low-latency interactive editing workflows on user terminals, and providing an extensible basis for integrating performance feedback into the selection and refinement of sentence generation patterns for subsequent model calls.

The term “processor” refers to a hardware or virtual computation unit, such as a central processing unit or a virtual machine processor, that executes instructions of a computer program to perform data processing operations specified in this specification.

The term “storage device” refers to a non-transitory computer-readable medium, such as a magnetic storage, optical storage, or semiconductor memory, that stores program code, input data, generated data, state information, and other information used by the processor.

The term “user terminal” refers to an information processing apparatus, such as a personal computer, a mobile terminal, or another network-capable device, that communicates with the server via a communication line and allows a user to input data and view or edit advertisement messages.

The term “communication line” refers to a wired or wireless communication network, including a local area network, a wide area network, and a public network, over which data is transmitted between the server and the user terminal or between the server and an external system.

The term “input data” refers to data transmitted from the user terminal to the server and including at least attribute information relating to a product or service to be advertised, appeal information, and advertisement format information.

The term “attribute information relating to a product or service to be advertised” refers to descriptive data identifying or characterizing a target item of advertising, such as a category, name, feature, specification, or other property of a product or service.

The term “appeal information” refers to information indicating selling points, advantages, or aspects to be emphasized in an advertisement for a product or service.

The term “advertisement format information” refers to information specifying a desired form of an advertisement, such as banner advertisement, text advertisement, or social media post, and may further include constraints such as output length or number of variants.

The term “validate the input data” refers to the operation of checking the presence of required items, the conformity to prescribed formats, and the conformity to length constraints or allowed value ranges, and rejecting or correcting input data that does not satisfy such conditions.

The term “normalize the input data” refers to the operation of transforming text or other data into a standardized representation, including at least removal of unnecessary character strings, unification of encoding, and standardization of notation such as punctuation or spacing.

The term “preprocessed structured data” refers to data obtained by validation and normalization of input data and organized into a structured format, such as key-value pairs or an object structure, suitable for machine processing and template-based insertion.

The term “sentence generation pattern” refers to a predefined pattern or template describing a structure of a natural language sentence, into which structured data is inserted to form a prompt sentence or other text for content generation.

The term “plurality of predefined sentence generation patterns” refers to two or more previously prepared sentence generation patterns that are stored in the system and selectable according to one or more conditions such as advertisement format, target attribute, or style condition.

The term “advertisement format” refers to a classification of the structure or delivery medium of an advertisement, including but not limited to banner advertisement, text advertisement, native advertisement, and social media advertisement formats.

The term “appeal item” refers to an element or theme to be emphasized in an advertisement, derived from appeal information, such as image quality, price advantage, convenience, or reliability.

The term “target attribute” refers to information representing characteristics of an intended audience for an advertisement, such as demographic attributes, interest categories, or usage scenarios.

The term “style condition” refers to a constraint or preference regarding linguistic style of a generated text, including tone, formality, enthusiasm level, or other stylistic parameters.

The term “prompt sentence” refers to a natural language text constructed from structured data and a sentence generation pattern, used as an input to a generative AI model to cause the model to generate an advertisement message.

The term “generative AI model” refers to a machine-learned model, such as a neural network language model, configured to receive an input including a prompt sentence and to probabilistically generate natural language text such as an advertisement message.

The term “request data including the prompt sentence” refers to data formatted according to an interface specification of a generative AI model, the data including at least the prompt sentence and optionally model parameters such as maximum length or temperature.

The term “external interface” refers to a communication mechanism, such as an application programming interface over a network, through which the server transmits request data to and receives responses from a generative AI model or other external processing resource.

The term “advertisement message candidate” refers to at least one piece of text or combined text returned by the generative AI model in response to a prompt sentence, before postprocessing or separation into individual advertisement messages.

The term “postprocessed advertisement messages” refers to advertisement messages obtained by processing an advertisement message candidate to conform to predetermined constraints, such as character-count constraints or expression constraints, and optionally separating the candidate into multiple messages.

The term “character-count constraint” refers to a condition specifying an allowed upper or lower bound on the number of characters or tokens in an advertisement message.

The term “expression constraint” refers to a condition restricting or requiring particular textual expressions, such as prohibiting certain terms, enforcing inclusion of a call-to-action phrase, or limiting the use of specific punctuation.

The term “unique identifier” refers to data used to uniquely identify a record or entity, such as an advertisement message, within the storage device or within a logical group of records.

The term “state information” refers to information indicating a processing status or lifecycle stage of an advertisement message or campaign, such as draft, edited, ready for submission, submitted, or delivered.

The term “screen data of an advertisement management screen” refers to data representing a user interface layout and content, including at least text regions for editing advertisement messages and elements for displaying and controlling processing states, which is transmitted from the server to the user terminal.

The term “text input region” refers to a portion of a user interface that accepts text input from a user, such as an editable text box or text area in which an advertisement message can be displayed and modified.

The term “processing states from advertisement creation through submission” refers to a series of states describing progression of an advertisement, from initial generation, through user editing and review, to final submission to an advertising platform or deployment system.

The term “template group” refers to a collection of sentence generation patterns or templates that share at least one common characteristic, such as suitability for a particular advertisement format, medium type, or target audience segment.

The term “medium type” refers to a classification of an advertisement delivery environment, including but not limited to web page placement, mobile application placement, email distribution, and social networking service distribution.

The term “maximum output character count” refers to a parameter defining an upper limit on the number of characters or tokens permitted for a generated advertisement message.

The term “number of outputs” refers to a parameter specifying how many advertisement message variants are to be generated for a given prompt sentence or request.

The term “tone type” refers to a characterization of the emotional or stylistic manner of a generated text, such as friendly, formal, casual, energetic, or authoritative.

The term “target segment type” refers to a classification of target audiences grouped according to shared characteristics, such as age group, profession category, or interest cluster.

The term “small or medium-sized business operator” refers to a business entity having relatively limited management resources, which typically requires simplified user interfaces and reduced configuration complexity to efficiently create advertisements.

The term “distribution result data” refers to data representing actual performance results of advertisement distribution, including at least impression counts, click counts, conversion counts, or revenue values associated with individual advertisement messages.

The term “click rate” refers to a ratio or percentage calculated from distribution result data, indicating how often an advertisement is clicked relative to a number of impressions or deliveries.

The term “conversion rate” refers to a ratio or percentage indicating how often a desired action, such as a purchase or registration, occurs relative to a number of advertisement interactions or impressions.

The term “revenue index” refers to a numerical value or metric derived from distribution result data and representing revenue-related performance of one or more advertisement messages.

The term “delivery volume index” refers to a numerical value or metric representing the scale or quantity of advertisement distribution, such as number of impressions, reach, or frequency.

The term “evaluation process” refers to processing performed by the processor to compute at least one performance indicator, such as click rate, conversion rate, revenue index, or delivery volume index, for use in assessing effectiveness of advertisement messages.

The term “feedback information” refers to information generated based on evaluation results and representing effectiveness or relative performance of certain combinations of appeal items, expression formats, and advertisement formats, for use in adjusting generation behavior or for user display.

The term “expression format” refers to a structural or stylistic configuration of an advertisement message, such as headline-focused text, bullet list, or short tagline form.

The term “selection conditions of the sentence generation patterns” refers to rules or criteria used by the processor to choose one or more sentence generation patterns from the plurality of predefined patterns, based on input data and optionally feedback information.

The term “generation conditions of the prompt sentence” refers to parameters or rules controlling how a prompt sentence is constructed, including which structured data fields are included, in what order they are inserted, and what meta-instructions or constraints are expressed to the generative AI model.

In one embodiment, a server, a terminal, and a user cooperate to implement the invention as a concrete computer-implemented system. The server includes at least one processor, a main memory, a non-transitory storage device, and one or more network interfaces. The server runs an operating system such as a general-purpose server operating system (for example, a UNIX-like operating system) and a web application stack including a web server, an application framework (for example, a Python-based or JavaScript-based framework), and a database management system (for example, a relational database engine). The terminal is an information processing apparatus such as a personal computer, a mobile computing device, or a tablet device, equipped with a display, an input interface, and a network interface, and executes a web browser or a dedicated application program. The user operates the terminal to input data and confirm and edit advertisement messages.

The server stores in the storage device a program that, when executed by the processor, causes the server to perform structured processing of advertisement-related data, construct and send a prompt sentence to a generative AI model, manage the responses as structured advertisement messages, and present these messages through an advertisement management screen. The server uses specific hardware and software resources to carry out these operations in a way that technically improves data handling and model interaction compared to conventional systems that merely forward text. The server uses the network interface to receive, from the terminal, input data including attribute information relating to a product or service to be advertised, appeal information, and advertisement format information. The server stores the raw input data in the storage device in a structured scheme, for example as rows in relational tables and as records in a key-value store. The server executes validation and normalization routines implemented as software modules. These routines use text-processing libraries (for example, regular expression engines and Unicode normalization libraries) to remove unnecessary character sequences, normalize whitespace and punctuation, and ensure that the data conforms to pre-defined schemas. The server converts the input data into a preprocessed structured data object containing fields such as product_description, key_benefits, ad_format, target_audience, maximum_length, and tone.

The server maintains in the storage device a plurality of sentence generation patterns. Each sentence generation pattern is represented as a data structure that includes template text with parameter placeholders, associated constraints (for example, maximum token length, prohibited terms), and applicability conditions (for example, applicable advertisement format, applicable medium type, applicable target segment). The server defines these sentence generation patterns as separate records in a template table, with fields such as template_id, template_body, applicable_format, applicable_medium, applicable_tone, and default_model_parameters. The server uses indexing structures over these fields so that the processor can efficiently select a subset of templates given the structured input data.

The server executes a selection algorithm that takes the preprocessed structured data as input and calculates a score for each candidate sentence generation pattern based on similarity between the structured data fields and the applicability conditions. The server may, for example, assign higher scores to patterns whose applicable_format matches the ad_format in the structured data and whose applicable_tone matches the requested tone. The server chooses one or more highest-scoring patterns and forms a sentence generation plan. This selection is not a simple static choice but a rule-based and data-driven computation that reduces search space and improves computational efficiency in subsequent generative model calls.

The server constructs a prompt sentence by embedding the fields of the structured data into the selected sentence generation pattern. The server uses a template rendering module to replace parameter placeholders with the values of the structured data. The server may, for example, construct a prompt sentence such as:
“You are a professional advertising copywriter. Create three short banner ad taglines (each under 15 words) for a new 5G smartphone called ‘X10’. Highlight its 48 MP ultra-high-resolution camera and all-day battery life. Target audience: young professionals. Tone: energetic and modern.”

The server may also construct another prompt sentence such as:
“You are an expert in social media advertising. Generate a single, punchy social media post (within 40 words) for an organic coffee brand. Emphasize fair trade sourcing, rich aroma, and smooth taste for busy office workers. Use a friendly and inviting tone.”

The server optimizes the composition of the prompt sentence by ensuring that the structured data is compactly represented and that essential constraints (such as length, tone, and number of variants) are encoded explicitly. This structured approach reduces unnecessary tokens and improves the computational efficiency of the generative AI model.

The server communicates with a generative AI model implemented as a trained neural network-based language model. In one embodiment, the generative AI model is a transformer-type neural network having multiple self-attention layers, feed-forward layers, and layer normalization blocks. The server treats the generative AI model as a remote computational resource exposed via an application programming interface. The server encapsulates the prompt sentence and model parameters (such as maximum number of output tokens, sampling temperature, and number of return sequences) into request data conforming to the external interface specification of the generative AI service.

The server sends the request data to the generative AI model over the communication line using a secure network protocol. The generative AI model internally tokenizes the prompt sentence, encodes the tokens as vector representations, and processes them through stacked self-attention layers configured with learned weight matrices. During inference, the generative AI model computes, for each generated token, a probability distribution over the vocabulary using a softmax operation applied to the output of its final layer. The generative AI model uses a decoding algorithm such as top-k sampling or nucleus sampling parameterized by the sampling temperature received in the request data to select the next token. The generative AI model repeats this process iteratively until a stopping condition, such as reaching the maximum number of output tokens or generating an end-of-sequence token, is satisfied. The generative AI model returns the generated token sequence as an advertisement message candidate.

In a training phase (which may be carried out beforehand and is not necessarily performed on the same server), the generative AI model is trained using a large corpus of natural language text including advertisement-like text and general descriptive text. The training process uses an optimization algorithm such as stochastic gradient descent or a variant (for example, adaptive moment estimation), an objective function such as cross-entropy loss comparing predicted token probabilities to actual tokens, and regularization techniques such as dropout within attention and feed-forward layers. The model parameters (weights and biases) are updated iteratively based on gradients computed by backpropagation. In some embodiments, the model is further fine-tuned using domain-specific data that includes advertisement messages associated with structured metadata (such as product category and tone) to improve relevance and style control.

The server receives the advertisement message candidate from the generative AI model in the form of a text sequence. The server uses a postprocessing module to parse the candidate into individual messages when the candidate contains multiple numbered or line-separated variants. The server examines the text and applies rules that detect delimiters such as line breaks or numeric prefixes (“1.”, “2.”, etc.). The server splits the candidate into segments and removes the numeric prefixes and extraneous formatting characters. The server then enforces character-count constraints by computing the character length or token length of each segment and truncating or discarding segments that violate specified thresholds. The server also applies expression constraints expressed as regular-expression or dictionary-based filters, for example to remove prohibited terms or enforce inclusion of a call-to-action phrase. The server thereby generates a plurality of postprocessed advertisement messages, each stored as a normalized string with associated metadata such as length, tone, and originating prompt.

The server writes these postprocessed advertisement messages to the storage device. For each advertisement message, the server generates a unique identifier and stores the identifier, the message text, the prompt sentence that led to its generation, the original input data, and state information indicating its workflow status. The server organizes this information into database tables with primary keys and foreign keys that preserve relationships between the user input, prompt sentences, generated messages, and subsequent edits. The server uses indexing on fields such as user_id, campaign_id, and state to accelerate retrieval operations required by the advertisement management screen.

The server generates advertisement management screen data and sends it to the terminal. The server synthesizes a data structure that includes the postprocessed advertisement messages, their unique identifiers, and their state information, as well as layout metadata indicating which messages appear in which editable text regions and which control elements (for example, buttons and status indicators) are associated with particular states. The server transmits this data as part of a web page or application view definition. The terminal's browser or application renders the advertisement management screen, showing each advertisement message in a text input region that the user can edit.

The user reads each advertisement message displayed on the terminal and edits the text directly in the text input regions. The terminal executes client-side code to capture each text change and maintain a local representation of the edited messages. The terminal may mark edited items with a visual indicator and provide controls for saving or submitting the edited messages. When the user triggers a save or submit operation, the terminal sends the edited text and associated identifiers back to the server via the communication line.

The server receives updated advertisement messages from the terminal and updates the corresponding records in the storage device. The server also updates the state information to reflect transitions such as “generated” to “edited” or “edited” to “ready for submission.” By capturing each edit and associating it with a prior generated version, the server maintains a versioned history that can be used later for analysis and auditing. This structure allows the server to distinguish automatically generated content from user-modified content and to relate performance metrics back to the underlying prompt sentence and structured data.

The server may further obtain distribution result data from external advertisement delivery platforms. The server stores, in association with each advertisement message, counts and metrics such as impressions, clicks, conversions, and revenue. The server executes an evaluation module that computes performance indicators such as click rate, conversion rate, revenue index, and delivery volume index. The server then correlates these indicators with the structured input data, the prompt sentences, and the sentence generation patterns used. The server may, for example, compute an average click rate for advertisement messages generated using a particular sentence generation pattern for a specific advertisement format and target audience, and compare this to averages for other patterns.

The server uses the evaluation results to adjust selection conditions for sentence generation patterns and to modify generation conditions for subsequent prompt sentences. For example, if the server determines that a particular pattern that emphasizes brevity achieves higher click rates for mobile banner advertisements, the server may increase the selection weight of that pattern for similar input data in future sessions. This feedback loop improves computational efficiency by biasing the model invocation toward patterns that historically yield better outcomes under similar constraints, reducing unnecessary exploratory calls to the generative AI model.

The server achieves technical effects beyond mere automation of human writing tasks. By transforming unstructured user input into preprocessed structured data and by programmatically selecting and instantiating sentence generation patterns, the server reduces the variability in prompt content and eliminates substantial noise before the generative AI model is invoked. This structured pipeline reduces the frequency of model outputs that are unusable or severely misaligned with requirements, thereby decreasing the number of repeated requests and improving throughput. Because the server also enforces length and expression constraints algorithmically after generation, the server offloads part of the constraint satisfaction from the model to deterministic algorithms that operate more efficiently and predictably.

The server also improves data management inside the computer system. The explicit association of each advertisement message with its input data, prompt sentence, and workflow state in a normalized relational or structured database enables fast indexed retrieval and update operations, even when a large number of messages are being handled simultaneously. This structure reduces disk access overhead and supports low-latency rendering of complex management screens on the terminal. The evaluation module that maps performance metrics back to sentence generation patterns and structured inputs further enhances computational efficiency by allowing the server to adapt pattern selection policies; this reduces average processing time and network load per successful advertisement message by steering generation toward historically effective prompt configurations. In one variant embodiment, the server uses different generative AI models for different advertisement formats. For example, the server may use a larger, more expressive transformer model with more attention layers for long-form social media posts and a smaller, low-latency model with fewer layers and reduced vocabulary for short text advertisements. The server maintains, for each model, separate default parameter sets and token-budget constraints, and chooses an appropriate model according to the ad_format field in the structured data. This configuration further optimizes the use of computational resources, reducing response times for short-form content without sacrificing quality where longer content is required.

In another variant embodiment, the server uses an intermediate feature representation that encodes the structured data and historical performance features into a numeric vector. The server may feed this vector into a lightweight policy model that outputs a selection probability distribution over the set of sentence generation patterns and model parameter configurations. The server thus uses machine-learned logic not only in the generative AI model but also in the upstream decision-making about prompts and parameters. This approach enables the server to capture complex correlations between input attributes and effective text structures, which cannot easily be encoded as static rules, and uses these correlations to reduce both communication overhead and computation time on the generative AI infrastructure.

The terminal operates as an interactive presentation and input device. The terminal renders the advertisement management screen in a way that minimizes bandwidth consumption by reusing static resources (such as cascading style sheets and script files) and by receiving only incremental updates of advertisement data when needed. The terminal uses asynchronous communication methods to request only changed advertisement messages or updated state information from the server, thereby reducing network load and latency perceived by the user.

The user uses the system to create, review, and manage advertisement messages but is not required to understand the internal technical operations. The user simply inputs product and appeal information, selects or confirms advertisement formats, and reads and edits generated messages. The server and terminal, through the above-described technical arrangements, perform data validation, structured prompt construction, optimized model invocation, constraint enforcement, storage association, and feedback-based refinement in a manner that improves system performance, data integrity, and quality of generated content.

Through these embodiments and variations, the system provides a concrete implementation that supports the claimed invention and enables a person skilled in the art to realize and modify the system while benefiting from the described technical improvements in processing speed, model efficiency, storage management, and adaptive prompt sentence design for a generative AI model.

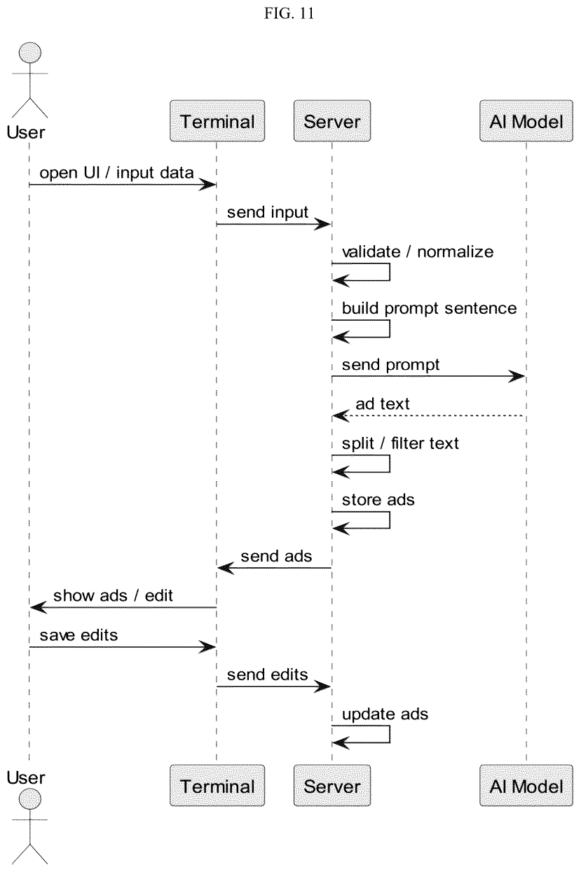

The following describes the processing flow using FIG. 11.

### Step 1:

The user operates the terminal to access an advertisement creation interface and inputs initial advertisement requirements.

The terminal displays an input screen including fields for product or service attributes, appeal information, advertisement format, target audience, and tone.

The input of this step is user keystrokes and selections entered into form controls on the terminal. The terminal converts these interactions into structured input values (for example, strings, list selections, and option flags) and stores them in a local state object.

The output of this step is a locally maintained set of input parameters on the terminal ready to be transmitted to the server.

### Step 2:

The terminal transmits the user's input parameters to the server.

The input of this step is the local state object holding the user-entered product attributes, appeal information, advertisement format, target audience, and tone.

The terminal encodes these parameters into a structured message, for example a JSON object with keys such as product_description, key_benefits, ad_format, target_audience, and tone, and sends this message via a network protocol to a designated server endpoint.

The terminal uses an HTTPS POST request and includes the structured data in the request body. The output of this step is a network request containing the structured input data delivered to the server.

### Step 3:

The server receives and validates the input data from the terminal.

The input of this step is the structured message transmitted by the terminal.

The server parses the message using a request-handling module, checks for missing required fields, verifies data types and length limits, and ensures that categorical values such as ad_format and tone are within predefined allowable sets.

The server performs data validation by comparing each field against a schema and, if necessary, returns an error response or applies default values for omitted optional fields.

The output of this step is a validated input data object in server memory that is guaranteed to conform to an internal schema.

### Step 4:

The server normalizes and cleans text fields in the validated input data.

The input of this step is the validated input data object.

The server executes text-processing routines that remove duplicate spaces, convert full-width characters to half-width where needed, unify line endings, normalize Unicode representations, and delete control characters or unwanted markup.

The server may standardize punctuation (for example, converting multiple exclamation marks to a single mark) and convert lists of appeal points into normalized string lists.

The server thus transforms the raw textual content into a consistent internal representation.

The output of this step is preprocessed structured data in which each text field is normalized for efficient downstream processing.

### Step 5:

The server constructs a structured representation for prompt generation.

The input of this step is the preprocessed structured data produced in Step 4.

The server maps each normalized field to standardized roles, such as product_description, key_benefits, primary_benefit, ad_format, medium_type, target_audience, tone, maximum_length, and desired_output_count.

The server may compute derived fields, for example concatenating multiple key benefits into one phrase separated by commas and “and”, or mapping an ad_format to a default maximum length. The server writes these fields into a prompt context object, which is a data structure specifically prepared for prompt construction.

The output of this step is a prompt context object containing all necessary information for selecting a sentence generation pattern and forming a prompt sentence.

### Step 6:

The server selects one or more sentence generation patterns based on the prompt context.

The input of this step is the prompt context object.

The server queries a template repository or database in which each sentence generation pattern has applicability conditions such as applicable ad_format, applicable medium_type, applicable target_audience, and applicable tone.

The server executes a selection algorithm that filters patterns whose conditions conflict with the prompt context, then ranks remaining patterns according to similarity scores or priority weights. For example, if ad_format is “banner” and tone is “energetic”, the server selects patterns explicitly marked for banner advertisements and energetic tone.

The output of this step is at least one selected sentence generation pattern that best matches the prompt context.

### Step 7:

The server generates a prompt sentence by embedding the prompt context into the selected pattern. The input of this step is the selected sentence generation pattern and the prompt context object.

The server executes a template-rendering operation, replacing placeholders in the pattern (such as {product_description}, {key_benefits}, {target_audience}, {tone}, {max_words}) with corresponding values from the prompt context.

The server may, for example, generate a prompt sentence such as:
“You are a professional advertising copywriter. Create three short banner ad taglines (each under 15 words) for a new 5G smartphone called ‘X10’. Highlight its 48 MP ultra-high-resolution camera and all-day battery life. Target audience: young professionals. Tone: energetic and modern.”

The server may also generate another prompt sentence such as:
“You are an expert in social media advertising. Generate a single social media post (within 40 words) for an organic coffee brand. Emphasize fair trade sourcing, rich aroma, and smooth taste for busy office workers. Use a friendly and inviting tone.”

The server ensures that the prompt sentence clearly encodes structural constraints and reduces unnecessary tokens.

The output of this step is a finalized prompt sentence and an associated set of model parameters ready to be sent to the generative AI model.

### Step 8:

The server prepares and sends a request to the generative AI model.

The input of this step is the prompt sentence and associated model parameters such as maximum token count, temperature, and number of outputs.

The server formats these into a request structure that conforms to an external interface specification, including fields for the prompt sentence, the identifier of the generative AI model, and configuration parameters.

The server then sends this request over a secure network channel to the generative AI model endpoint using an API call.

The output of this step is a transmitted request invoking the generative AI model with the specified prompt sentence and parameters.

### Step 9:

The server receives an advertisement message candidate from the generative AI model.

The input of this step is the response data returned by the generative AI model.

The server parses the response to extract at least one generated text sequence representing an advertisement message candidate.

If the response includes multiple sequences or variants, the server arranges them as elements within an internal list structure.

The output of this step is an advertisement message candidate set, represented as one or more raw generated text strings.

### Step 10:

The server splits and cleans the advertisement message candidate into individual messages.

The input of this step is the advertisement message candidate set.

The server scans each candidate text for separators such as line breaks, numbered list prefixes, or delimiter tokens, and splits the text into separate segments.

The server removes numbering symbols, extra whitespace, and formatting artifacts from each segment and discards empty or trivial segments.

The server thus produces a preliminary list of advertisement messages.

The output of this step is a list of normalized advertisement message segments, each representing a candidate advertisement message.

### Step 11:

The server enforces character-count and expression constraints on the candidate messages.

The input of this step is the list of normalized advertisement message segments and the constraint parameters stored in the prompt context (such as maximum_length and required phrases).

The server computes the character length or token length of each segment and compares it with the stored maximum_length.

The server truncates or rejects segments that exceed allowed length, and applies expression filters to check for prohibited words or to confirm the presence of required expressions such as a call to action.

The server removes or adjusts segments that fail expression constraints.

The output of this step is a refined set of postprocessed advertisement messages that comply with predefined length and expression rules.

### Step 12:

The server stores the postprocessed advertisement messages and associated metadata.

The input of this step is the refined set of postprocessed advertisement messages, the original prompt sentence, and the validated input data.

The server generates a unique identifier for each advertisement message and writes records into a storage structure that includes fields for message_id, user_id, campaign_id, message_text, source_prompt, input_snapshot, and state (for example, “generated”).

The server also creates or updates an aggregate record for the advertisement campaign that references the newly created messages.

The output of this step is a persistent database state in which each advertisement message is stored and linked to its originating prompt sentence and input data.

### Step 13:

The server generates advertisement management screen data for the terminal.

The input of this step is the stored advertisement messages and their state information.

The server constructs a representation of an advertisement management interface, including a list of messages, their identifiers, current states, and configuration for editable text regions and control elements.

The server may prepare the data in a format directly consumable by a front-end framework, specifying for each message its text, editability, and associated actions (such as save or submit). The output of this step is advertisement management screen data transmitted to the terminal over the communication line.

### Step 14:

The terminal renders the advertisement management screen and collects user edits.

The input of this step is the advertisement management screen data received from the server.

The terminal constructs user interface components that display each advertisement message in an editable text region, show the current state, and expose buttons or controls for saving and submitting. The user edits message text directly on the terminal; the terminal updates its local representation of each message as the user types and marks messages that have been changed.

When the user invokes a save or submit control, the terminal collects the edited texts and their identifiers into an update payload.

The output of this step is an update payload containing edited message texts and corresponding identifiers ready to be sent to the server.

### Step 15:

The terminal transmits edited messages to the server for storage and state update.

The input of this step is the update payload generated in Step 14.

The terminal sends this payload as a structured message, including the message identifiers, edited texts, and desired next state (for example, “edited” or “ready_for_submission”), using an HTTPS request to a designated server endpoint.

The output of this step is a network request carrying updated advertisement content and state-change instructions to the server.

### Step 16:

The server updates stored messages and workflow states based on the user's edits.

The input of this step is the update payload received from the terminal.

The server locates each corresponding record in the storage device using the identifiers contained in the payload and writes the edited text into the message_text field, while also updating the state field to reflect progression in the workflow.

The server may log the previous versions to maintain a history and may compute a hash or version identifier for each updated message.

The output of this step is an updated persistent database state where advertisement messages and their states reflect user edits and are ready for subsequent analysis or distribution.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented systems for creating advertisement campaigns require a human operator to manually transform product information and business requirements into machine-readable input for automated tools, and to manually manage the entire lifecycle from creative generation to submission to distribution platforms. In many cases, user interfaces merely collect free-form text and pass it directly to a text generation engine without systematic preprocessing, prompt structuring, or postprocessing. As a result, the quality and consistency of generated advertisement messages depend heavily on the user's expertise in prompt design and on ad-hoc, manual iteration. This leads to unstable generation behavior, redundant or malformed outputs, and significant trial-and-error, thereby increasing processing load on computer resources and decreasing overall throughput of the advertisement generation pipeline.

Furthermore, conventional systems typically lack an integrated mechanism that links input normalization, prompt sentence construction, generative AI model execution, structured result formatting, user-side interactive editing, and downstream campaign submission control into a single, coherent processing flow. Instead, these tasks are fragmented across separate software modules and interfaces. Such fragmentation forces repeated data conversions between heterogeneous formats, increases latency due to unnecessary data transfers, and complicates state management within server-side applications. This degrades system-level efficiency and makes it difficult to scale the system for a large number of small business users who require rapid and reliable advertisement generation.

Additionally, conventional systems often do not use structured advertisement format information to systematically influence the behavior of the generative AI model. While some tools allow selection of an advertisement “type” (such as a banner or social media post), this information is rarely normalized into internal identifiers and integrated into a prompt structure recognized by the generative AI model. Consequently, generated outputs may fail to respect format-specific constraints, such as character limits, layout expectations, or required content elements. This mismatch between user-selected formats and model behavior leads to additional manual editing and re-generation cycles, which wastes computational resources and impairs the responsiveness of the system.

Moreover, in many existing systems, performance analysis of generated advertisement messages and feedback to the generative process are handled outside the core computational pipeline, if at all. Even when performance data from external advertisement distribution platforms is available, it is often not computationally linked with the underlying generation parameters or prompt structures. The absence of such feedback integration means the system cannot automatically adjust prompts, templates, or generation strategies based on observed outcomes, resulting in suboptimal use of computing resources and persistent generation of low-performing advertisement variants. Therefore, there is a need for an improved computer-implemented system that, at the processor level, (i) normalizes and structures user input including advertisement target information, appeal information, and advertisement format information; (ii) constructs and converts prompt sentences into model input data suitable for a generative AI model; (iii) decodes and structures generated results into machine-usable advertisement components; (iv) coordinates interactive editing and approval on user terminals; and (v) centrally manages submission and scheduling with external advertisement distribution platforms, while enabling data-driven feedback to improve the generation process. Such a system should enhance the determinism, efficiency, and scalability of the generative AI pipeline itself, thereby improving computer technology in the field of automated advertisement campaign generation.

The specific processing by the specific processing unit 290 of the data processing device 12 in Application Example 1 is realized by the following means.

The present invention provides a server comprising a processor configured to receive, from a user terminal, input information including advertisement target information, appeal information, and advertisement format information; preprocess the input information by normalizing character data, unifying encoding formats, removing unnecessary characters, and converting the advertisement format information into an internal identifier; construct, based on the preprocessed input information, a prompt sentence in natural language that incorporates the advertisement target information, the appeal information, and the advertisement format information, and convert the prompt sentence into model input data suitable for a generative AI model; input the model input data to the generative AI model to cause the generative AI model to generate result data including an advertisement message and advertisement campaign configuration information; decode and format the result data into structured advertisement information including headline information, body information, call-to-action information, and advertisement distribution meta information; transmit the structured advertisement information to a user interface of the user terminal having a preview screen and an editing screen so as to enable user confirmation and editing; and receive, from the user terminal, edited advertisement information and approval information and store the edited advertisement information while centrally managing submission of the advertisement information to an external advertisement distribution platform and management of a distribution schedule. This enables an integrated and computationally optimized advertisement generation pipeline in which input normalization, prompt construction, generative AI model execution, structured output formatting, interactive editing, and distribution control are coordinated within a single server-controlled workflow, thereby improving the efficiency, scalability, and reliability of computer systems that generate and manage advertisement campaigns.

The term “processor” refers to one or more hardware-implemented computation units, such as a central processing unit or a graphics processing unit, configured to execute instructions that implement the functions of the system.

The term “user terminal” refers to an information processing apparatus operated by a user, such as a portable terminal, a desktop device, or a browser-based client, that transmits input information to the server and displays output information from the server.

The term “input information” refers to information received from the user terminal, including at least advertisement target information, appeal information, and advertisement format information, which is used as a basis for subsequent processing by the processor.

The term “advertisement target information” refers to information indicating an object of advertisement, such as a product, a service, or a brand, that is to be promoted by an advertisement campaign.

The term “appeal information” refers to information indicating features, advantages, or selling points of the advertisement target that are to be emphasized in an advertisement message.

The term “advertisement format information” refers to information indicating a desired type, layout, or style of an advertisement, such as a display advertisement, a social media post, or a video script, which constrains the structure and length of the generated advertisement message.

The term “normalizing” refers to processing character data to achieve a unified representation, including unifying character encoding formats, harmonizing character variants, and converting text into a canonical form suitable for machine processing.

The term “encoding format” refers to a representation scheme for digital characters, such as a character encoding standard, that specifies how characters are mapped to digital codes.

The term “unnecessary characters” refers to characters or symbols, such as redundant whitespace, control characters, or noise symbols, that do not contribute to the semantic content required for advertisement message generation and are removed during preprocessing.

The term “internal identifier” refers to a machine-readable code or symbol that is associated with an advertisement format or other parameter and is used internally by the system to control processing logic and generative behavior.

The term “prompt sentence” refers to a natural language sentence or text sequence constructed by the processor, which incorporates advertisement target information, appeal information, and advertisement format information, and is used as an input instruction to a generative AI model.

The term “model input data” refers to a representation of the prompt sentence converted into a format suitable for input to a generative AI model, such as token sequences, numerical vectors, or tensors.

The term “generative AI model” refers to a machine learning model capable of generating content, such as a neural network-based language model, that receives model input data and outputs generated result data including advertisement messages and campaign-related information.

The term “result data” refers to output data generated by the generative AI model, including at least one advertisement message and advertisement campaign configuration information before decoding and structuring.

The term “advertisement campaign configuration information” refers to information indicating a structure of an advertisement campaign, such as target audience description, distribution channel suggestion, or scheduling-related metadata, that is generated or derived in association with an advertisement message.

The term “decode” refers to processing that converts model-generated output representations, such as token identifiers or encoded sequences, into human-readable character strings.

The term “structured advertisement information” refers to advertisement-related data organized into predetermined fields, including at least headline information, body information, call-to-action information, and advertisement distribution meta information, which can be processed by the system and displayed to the user.

The term “headline information” refers to text representing a main title or leading phrase of an advertisement, intended to attract attention in a concise form.

The term “body information” refers to text representing descriptive content of an advertisement, including explanation of features, benefits, or usage of the advertisement target.

The term “call-to-action information” refers to text encouraging a user to perform a specific action, such as purchasing, registering, or accessing content, as part of an advertisement message.

The term “advertisement distribution meta information” refers to metadata associated with advertisement distribution, such as intended distribution channels, format identifiers, scheduling hints, or targeting parameters.

The term “user interface” refers to a logical interface, such as a graphical user interface screen or a web page, through which the user terminal presents information to a user and receives user operations.

The term “preview screen” refers to a display screen of the user interface that visually simulates how an advertisement will appear when distributed, using the structured advertisement information.

The term “editing screen” refers to a display screen of the user interface that provides input fields or controls allowing the user to modify elements of the structured advertisement information.

The term “edited advertisement information” refers to advertisement content that has been modified by the user based on the structured advertisement information, including changes to headline information, body information, call-to-action information, or other components.

The term “approval information” refers to information indicating that a user has approved a particular version of the advertisement information for use in an advertisement campaign and for submission to distribution platforms.

The term “external advertisement distribution platform” refers to an external system or service that distributes advertisements to end users through communication networks, such as an online advertisement network, a social media advertisement system, or another digital advertisement delivery infrastructure.

The term “advertisement distribution management screen” refers to a management interface provided by the server that enables monitoring, scheduling, and control of advertisement distribution, including submission status and campaign timing.

The term “distribution schedule” refers to information specifying a time period or timing conditions under which an advertisement is to be distributed by an external advertisement distribution platform. The term “advertisement template information” refers to predefined structural patterns for advertisements, such as field layouts, text length constraints, and content element arrangements, associated with particular advertisement format information and selectable by a user.

The term “business entity having a small business scale” refers to an organization or operator with limited resources or size, for which simplified and guided advertisement creation operations are particularly beneficial.

The term “advertisement distribution performance information” refers to information obtained from an external advertisement distribution platform indicating performance metrics of distributed advertisements, such as impressions, click-through rates, conversions, or cost-related data.

The term “performance indicators” refers to quantitative or qualitative metrics derived from advertisement distribution performance information and used to evaluate the effectiveness of an advertisement message or campaign.

The term “improvement suggestion information” refers to information generated by the processor based on analysis of performance indicators, indicating recommended modifications to advertisement content, formats, or campaign parameters to enhance performance, monetization, or advertisement placement volume.

In one embodiment, a server, a terminal, and a user cooperate to implement a system for generating and managing advertisement campaigns using a generative AI model in a way that improves computer processing of text generation, data structuring, and campaign control.

### A. Hardware and Software Configuration

A server includes at least one processor, a main memory, a storage device, a communication interface, and, in some embodiments, a hardware accelerator. The processor is, for example, a general-purpose central processing unit or a combination of a central processing unit and a graphics processing unit. The main memory is, for example, a volatile memory. The storage device is, for example, a non-volatile storage. The communication interface is configured to communicate with the terminal and with external advertisement distribution platforms through a communication network. The server executes a server-side application implemented in a high-level language such as Python running on an operating system such as a server operating system. The server further executes a machine learning framework such as a tensor computation framework, which provides tensor data structures, automatic differentiation, and neural network execution.

The terminal is, for example, a smartphone, a tablet, or a personal computer. The terminal includes a processor, a display, an input device, a memory, and a communication interface. The terminal executes a web browser or a native client application that implements a user interface. The user interacts with the user interface to supply advertisement-related information and to review outputs from the server.

### B. Program Structure and Data Structures

The server stores program modules including at least an input reception module, a preprocessing module, a prompt construction module, a tokenization and encoding module, a generative AI inference module, a postprocessing and structuring module, a user interface communication module, a campaign management module, and a feedback analysis module.

The server uses internal data structures to handle information. For example, the server represents input information as a record containing fields such as:
target_object: a character string representing the advertisement target,
appeals: a list of character strings representing selling points,
format_code: an internal identifier indicating an advertisement format,
language_code: a code indicating a language of the advertisement,
constraints: a set of values indicating length limits or tone preferences.

The server represents model input data as tensor structures, such as integer sequences corresponding to token identifiers, together with attention masks indicating valid token positions. The server represents generated result data as sequences of token identifiers and associated scores. The server represents structured advertisement information as records containing fields such as:
headline_text,
body_text,
call_to_action_text,
meta: a sub-record including format_code, estimated length, and recommended display style.

The server uses separate records to store campaign configuration information, including:
campaign_id,
target_channels,
schedule_start,
schedule_end,
budget_range,
performance_metrics.

### C. Preprocessing and Prompt Sentence Construction

The server receives, from the terminal, text data entered by the user and encoded, for example, in a standard character encoding. The server stores the received data in an input buffer and parses it into the input information record.

The server performs normalization on the character data by applying Unicode normalization, converting full-width characters to half-width characters where appropriate, unifying line break codes, and reducing multiple whitespace characters to a single space. The server removes unnecessary control characters and non-printable symbols that may interfere with tokenization by the generative AI model. The server also maps user-selected textual format labels to internal identifiers, such as mapping “social media short post” to an internal code “SNS_SHORT” and mapping “display banner” to “BANNER_MEDIUM_RECTANGLE”.

The server constructs a prompt sentence by applying a template to the normalized input information. For example, the server uses a template such as:
“Generate an advertisement campaign for the following product. Product: [PRODUCT_NAME]. Selling points: [APPEALS]. Advertisement format: [FORMAT_DESCRIPTION]. Provide a compelling headline and body text.”

The server replaces [PRODUCT_NAME] with the normalized target_object string, replaces [APPEALS] with a comma-separated list of normalized appeals, and replaces [FORMAT_DESCRIPTION] with a phrase corresponding to the internal format_code. As a concrete example, when the user provides information about a new smartphone with a high-resolution camera and a long-lasting battery, the server may generate a prompt sentence such as:
“Generate an advertisement campaign for the launch of a new smartphone. Product name: model X. Selling points: high-resolution camera, long-lasting battery. Advertisement format: short social media feed post. Provide a catchy headline and a persuasive body text under 80 words.”

In another example, the server may generate a variant prompt sentence to obtain multiple candidates: “Create three alternative advertisement headlines and body texts for an online ad promoting a new smartphone with a high-resolution camera and a long-lasting battery. Each version should target young professionals and use an energetic tone.”

By standardizing the mapping from structured fields to prompt sentences, the server reduces variability in inputs to the generative AI model and improves stability and reproducibility of the generated outputs.

### D. Tokenization, Encoding, and Generative AI Model Architecture

The server employs a tokenizer associated with the generative AI model. The tokenizer performs subword segmentation based on a pre-learned vocabulary file and maps each subword to an integer identifier. The server converts the prompt sentence into a sequence of integer identifiers, such as [t1, t2, . . . , tN]. The server then applies padding or truncation to adjust the sequence to a fixed maximum length L, and constructs an attention mask indicating positions corresponding to valid tokens.

The generative AI model is, in one embodiment, a transformer-based neural network including an embedding layer, a plurality of self-attention layers, feed-forward layers, and an output projection layer. The embedding layer maps each token identifier to a dense vector of a fixed dimension, for example, dimension d. The self-attention layers compute attention weights among tokens using scaled dot-products and combine token representations using weighted sums. The feed-forward layers apply non-linear transformations to the intermediate representations. The output projection layer maps the final hidden state at each position to a probability distribution over the vocabulary. The server trains the generative AI model in advance using a training dataset including advertisement texts and campaign-related texts. The server applies a training algorithm such as stochastic gradient descent or a variant with adaptive learning rates. During training, the server minimizes a loss function such as cross-entropy between predicted token distributions and ground-truth token sequences. The server updates the weights of the network by backpropagation using gradients computed by automatic differentiation provided by the tensor computation framework. The server may apply data augmentation strategies, such as paraphrasing or random masking, to improve robustness.

In operation, the server uses the trained generative AI model in inference mode. The server inputs the encoded token sequence and attention mask to the model. The server uses a decoding algorithm, such as top-k sampling or nucleus sampling, possibly with a temperature parameter, to generate a sequence of output token identifiers representing an advertisement headline and body. By adjusting the sampling parameters and including format_code information in the prompt sentence, the server influences the length and style of the generated text in a systematic manner.

### E. Postprocessing, Structuring, and Transmission

The server decodes the sequence of output token identifiers into a character string using the tokenizer's inverse mapping. The server then applies rule-based postprocessing, for example:
trimming leading and trailing whitespace,
collapsing repeated punctuation,
removing unprintable characters,
enforcing maximum length constraints specific to the format_code.

The server analyzes the decoded text to detect delimiters introduced by the prompt structure, such as “Headline:” and “Body:”. The server splits the text into headline_text and body_text accordingly. If the prompt requests a call to action, the server similarly extracts a segment for call_to_action_text. The server constructs the structured advertisement information record and populates the headline_text, body_text, call_to_action_text, and meta fields. The meta field includes, for example, the format_code, an estimated character count, and a recommended preview layout type, such as “SNS_CARD” or “BANNER_RECT”.

The server transmits the structured advertisement information to the terminal over a communication network using a protocol such as HTTPS. The terminal receives the structured data, parses it, and renders it in the user interface. The terminal displays a preview screen that visually simulates the final advertisement appearance based on the format_code, and provides editable fields reflecting the headline_text, body_text, and call_to_action text.

The user reviews the generated advertisement on the terminal and may modify the text using the editing screen. The terminal transmits edited advertisement information and an approval indication to the server when the user approves the content.

### F. Campaign Management and Feedback Processing

The server stores the edited advertisement information and approval indication in the storage device as part of a campaign record. The server converts the structured advertisement information and campaign parameters into a format required by an external advertisement distribution platform. The server then submits the advertisement and schedule to the external platform by sending an appropriate request through the communication interface.

The external advertisement distribution platform later reports performance data, such as impressions, click counts, and conversions, to the server. The server stores this advertisement distribution performance information and associates it with the corresponding campaign record.

The server analyzes performance indicators by computing, for example, click-through rates, conversion rates, and cost per action. The server can use a separate analysis model or rule-based algorithm to map performance indicators to improvement suggestion information. For example, the server may detect that headlines with certain phrase patterns perform better and propose suggestions to modify future headlines accordingly.

In one embodiment, the server uses performance indicators to influence future prompt construction, by including constraints or additional instructions in subsequent prompt sentences. For example, the server may generate a prompt sentence such as:
“Generate an advertisement headline and body that are similar in tone to previously high-performing ads emphasizing a high-resolution camera and a long-lasting battery, while remaining under 60 characters for the headline.”

By feeding back performance-derived constraints into the prompt sentence and into the choice of sampling parameters, the server improves the relevance and effectiveness of the generative AI model outputs. This feedback loop modifies internal model input data structures and decoding behavior at the server side and thereby improves computational efficiency, because fewer generations and manual corrections are required to reach satisfactory performance.

### G. Technical Effects and Improvement of Computer Technology

The server improves computer technology in several ways. First, by normalizing and structuring user input before constructing the prompt sentence, the server reduces entropy and noise in the generative AI model input. This reduces the variance of the model's output distribution and yields more predictable outputs, which decreases the number of required generation cycles and thus reduces processing time and computation load.

Second, by systematically embedding structured format_code information and constraints into the prompt sentence and by controlling sampling parameters based on that information, the server causes the generative AI model to produce outputs that more closely match format-specific requirements. This reduces postprocessing overhead and reduces the amount of data transmitted between the server and the terminal, thereby decreasing communication load.

Third, by using a transformer-based architecture with precomputed token embeddings and efficient attention computations, and by mapping internal identifiers to concise control tokens embedded in the prompt sentence, the server performs multi-step generation with fewer forward passes than naive approaches that would separately generate each field. This improves throughput and scalability when servicing many terminals concurrently.

Fourth, by integrating campaign performance information into subsequent prompt construction and generation parameter selection, the server implements a non-conventional feedback mechanism that adapts the generative pipeline at the level of data structures and control flow, rather than relying on human trial-and-error. This adaptation reduces the need for full retraining while still improving the quality of generated outputs, and leads to reduced error rates and improved alignment with desired performance metrics.

Fifth, the server uses rule-based validation and filtering in combination with the generative AI model, where explicit constraints (for example, maximum character lengths, prohibited terms, or required disclaimers) are enforced at the token and text level. This layered approach is different from human editing and avoids the computational cost of discarding entire generations due to policy violations. Instead, the server selectively regenerates specific segments or applies corrective transformations, resulting in more efficient use of computation resources.

### H. Variations and Alternative Embodiments

In another embodiment, the server uses a sequence-to-sequence generative AI model with an encoder-decoder structure, where the encoder processes a structured representation of the input information and the decoder generates advertisement text. In such a case, the server constructs a feature vector for each field (target_object, appeals, format_code) and concatenates them into a structured input sequence for the encoder. The encoder produces a context representation, and the decoder generates output tokens conditioned on this context. The same tokenizer and normalization principles apply.

In a further embodiment, the server uses multiple generative AI models specialized for different advertisement formats. The server selects an appropriate model based on format_code, and the preprocessing and prompt construction remain unified. This specialization can improve generation speed and accuracy for specific formats, such as short social media posts or long-form advertorials. In yet another embodiment, the server runs part of the preprocessing or postprocessing at the terminal, for example, by performing preliminary normalization in the terminal application to reduce data volume. However, the core generative AI model execution, structured data formation, and campaign feedback loop remain controlled by the server.

The server, the terminal, and the user thus cooperate to implement a system in which generative AI operations are tightly bound to specific data structures, control flows, and performance-driven feedback. The combination of structured prompt construction, transformer-based generation, rule-based postprocessing, and integrated campaign management yields a measurable improvement in processing efficiency, output quality, and resource utilization compared to conventional systems that merely automate human advertisement writing without such technical structuring and feedback.

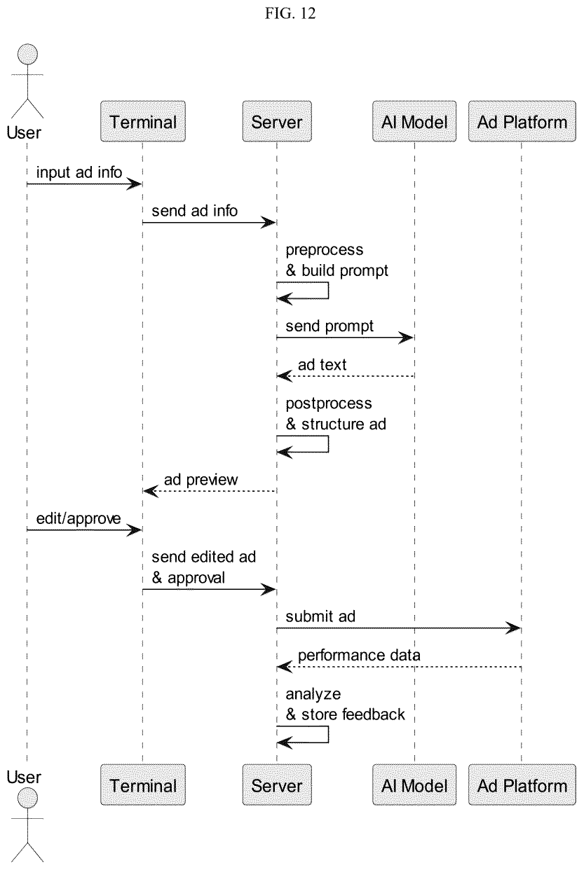

The following describes the processing flow using FIG. 12.

### Step 1:

User operates the terminal and opens a user interface for advertisement creation.

User inputs advertisement target information, appeal information, and advertisement format information into input fields on the terminal screen.

The input of this step is raw textual and selection data entered by the user (for example, product name, selling points, and chosen format type).

The output of this step is a structured set of user inputs held in the terminal's application state, such as an internal object containing the typed strings and selected format.

### Step 2:

Terminal converts the structured set of user inputs into a transmission-ready data structure.

Terminal maps each input field (for example, product name, selling points list, format selection) to corresponding keys in a data record, encodes all text as character data, and encapsulates the record into a message.

The input of this step is the internal object holding the user's inputs.

The output of this step is a serialized data message that includes advertisement target information, appeal information, and advertisement format information, ready to be sent to the server via a communication protocol.

### Step 3:

Terminal transmits the serialized data message to the server through a communication interface. Terminal establishes a secure connection, attaches the data message to a request, and sends the request to a predefined server endpoint.

The input of this step is the serialized data message containing the user's advertisement inputs. The output of this step is a network request delivered to the server and a corresponding acknowledgment or response header received from the server confirming receipt.

### Step 4:

Server receives the network request via a communication interface and parses the transmitted data message.

Server decodes the message, checks message integrity, and maps the received keys and values into an internal input information structure that includes fields for advertisement target information, appeal information, and advertisement format information.

The input of this step is the serialized data message sent by the terminal.

The output of this step is a normalized internal input information record stored in server memory for further processing.

### Step 5:

Server performs character-level normalization and cleanup on the input information. Server applies encoding normalization, removes unnecessary control characters, collapses repeated whitespace, converts locale-specific character variants to a canonical form, and verifies that mandatory fields are not empty.

The input of this step is the internal input information record containing raw character strings.

The output of this step is a cleaned and encoding-normalized input information record in which all text fields are suitable for subsequent tokenization and prompt construction.

### Step 6:

Server maps advertisement format information from human-readable selections to internal identifiers and structural constraints.

Server uses a stored mapping table to convert a format label (for example, “short social media post”) into an internal code (for example, “SNS_SHORT”) and retrieves associated constraints such as maximum headline length, maximum body length, and layout type.

The input of this step is the cleaned input information record containing a user-selected format label. The output of this step is an augmented input information record that now includes an internal format_code field and attached constraint parameters.

### Step 7:

Server constructs a prompt sentence in a natural language by applying a template to the augmented input information record.

Server combines the advertisement target information, appeal information, and format-related descriptions into a structured prompt sentence, inserting normalized values into template placeholders.

For example, server may create the following prompt sentence as output:
“Generate an advertisement campaign for the launch of a new smartphone. Product name: model X. Selling points: high-resolution camera, long-lasting battery. Advertisement format: short social media feed post. Provide a catchy headline and a persuasive body text under 80 words.”

The input of this step is the augmented input information record with target_object, appeals, and format_code.

The output of this step is a prompt sentence string ready for tokenization and input to the generative AI model.

### Step 8:

Server tokenizes the prompt sentence and encodes it into model input data suitable for the generative AI model.

Server applies a tokenizer to segment the prompt sentence into subword units and maps each unit to a corresponding integer identifier; server then pads or truncates the sequence to a fixed length and creates an attention mask to mark valid positions.

The input of this step is the prompt sentence string produced in the previous step.

The output of this step is a set of model input data structures, including a sequence of token identifiers and an attention mask, both represented as numerical arrays or tensors in server memory. Step 9:

Server executes the generative AI model using the model input data to produce generated result data. Server passes the token identifier sequence and attention mask into a neural network, such as a transformer-based language model, and performs forward propagation through embedding layers, attention layers, and feed-forward layers; server then applies a decoding algorithm (for example, top-k sampling with a temperature parameter) to iteratively select output tokens that form an advertisement headline and body.

The input of this step is the numerical model input data containing token identifiers and an attention mask.

The output of this step is a generated result data sequence, typically a series of token identifiers representing the model's predicted advertisement text and associated probability scores.

### Step 10:

Server decodes the generated token identifiers into human-readable text and separates structural components.

Server converts the token identifiers back into character strings using the tokenizer's vocabulary, and then uses predefined delimiters or patterns to split the text into components such as headline_text, body_text, and optionally call_to_action_text.

The input of this step is the generated result data sequence of token identifiers and scores.

The output of this step is a set of decoded text segments corresponding to different parts of the advertisement content.

### Step 11:

Server applies postprocessing rules and assembles structured advertisement information.

Server trims excessive whitespace, enforces character length constraints according to the format_code, removes prohibited words or patterns by matching against rule sets, and, if necessary, regenerates or adjusts specific segments while preserving others.

The input of this step is the set of decoded text segments and the constraint parameters associated with the format_code.

The output of this step is a structured advertisement information record containing validated headline_text, body_text, call_to_action_text, and advertisement distribution meta information such as preview type and estimated text lengths.

### Step 12:

Server transmits the structured advertisement information to the terminal for preview and editing. Server encapsulates the structured advertisement information in a response message, sends the message to the terminal over a secure connection, and records that an initial generation has been delivered for this campaign.

The input of this step is the structured advertisement information record residing in server memory. The output of this step is a response message delivered to the terminal, containing all fields required to render the preview and editing screens.

### Step 13:

Terminal receives the response message from the server and renders a preview of the generated advertisement.

Terminal parses the structured advertisement information, maps fields to user interface elements, and displays a preview screen showing the headline, body, and optional call to action in a layout that reflects the advertisement format.

The input of this step is the response message with structured advertisement information.

The output of this step is a visual representation of the advertisement on the terminal's display, along with editable input fields populated with the generated texts.

### Step 14:

User reviews the displayed advertisement on the terminal and optionally edits the content.

User reads the headline and body and may modify words, phrases, or entire sentences using the editing fields; user may also instruct the terminal to request regeneration if the current version is unsatisfactory.

The input of this step is the initially displayed structured advertisement information as rendered by the terminal.

The output of this step is user-edited advertisement text or a regeneration request captured within the terminal's application state.

### Step 15:

Terminal sends edited advertisement information and approval status to the server.

Terminal packages the user's edited texts and any indication of approval or regeneration request into a new data message and transmits this message to the server.

The input of this step is the user-edited advertisement content and user action (approve or request change) as stored locally on the terminal.

The output of this step is a transmitted data message reaching the server, containing updated advertisement content and control flags indicating the user's decision.

### Step 16:

Server processes the edited advertisement information and, when approval is indicated, updates campaign records and prepares for external distribution.

Server validates that required fields remain present after editing, stores the edited advertisement content into a persistent campaign record, and, if the user has approved, converts the stored campaign data into a format suitable for an external advertisement distribution platform and schedules submission.

The input of this step is the data message from the terminal containing edited content and approval status.

The output of this step is an updated campaign record in server storage and, when applicable, a prepared set of distribution instructions ready to be sent to external platforms.

### Step 17:

Server optionally analyzes performance data from external advertisement distribution platforms and generates improvement suggestions for future generations.

Server receives advertisement distribution performance information, correlates it with campaign records, computes performance indicators such as click-through rates, and derives improvement suggestion information that may include recommended changes to headlines, appeals, or formats. The input of this step is the performance data from external platforms and the stored campaign records.

The output of this step is a set of derived performance indicators and improvement suggestion information that the server can incorporate into subsequent prompt sentence construction or display to the user in later sessions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In conventional computer-implemented advertising systems, generation of advertisement text largely depends on manual authoring by human operators using generic content creation tools. Even when a generative AI model is introduced, the model is often invoked in an ad hoc manner: an operator manually crafts a prompt sentence, submits the prompt sentence to the model, and manually copies the result into an advertising platform. Such workflows suffer from several technical deficiencies. First, the server-side processing does not systematically analyze structured input from terminal devices to extract product characteristics and appeal elements, and therefore cannot automatically construct optimized prompt sentences tailored to specific advertisement formats and constraints. As a result, the generative AI model frequently produces outputs that fail to satisfy character-count constraints, component-structure constraints, or platform-specific requirements, leading to repeated trial-and-error invocations and increased processing overhead on networked computing resources.

Second, existing systems typically treat text and image generation as separate, loosely coupled processes. A server that generates advertisement text rarely coordinates that text with image-generation processing by an image-generative AI model in an integrated manner. Consequently, the server does not maintain consistent associations between advertisement text and advertisement image data, and cannot systematically manage advertisement creatives as unified digital objects that can be reliably submitted to external distribution platforms. This separation results in redundant storage operations, inconsistent metadata management, and an increased risk of mismatches between the text and the corresponding image in the final delivered advertisement.

Third, user interfaces for small-scale business operators are often implemented as generic web forms that are not tightly integrated with server-side optimization logic. Such terminals typically provide only static templates without dynamically reflecting server-side analysis of advertisement effectiveness or constraints imposed by external distribution platforms. This lack of integration prevents the server from adaptively guiding the user toward higher-performing advertisements, and makes it difficult to implement a one-stop workflow in which the same system both generates and submits creatives. In addition, conventional systems do not effectively exploit server-side feedback loops based on advertisement delivery result information, and therefore cannot automatically refine prompt sentences or advertisement condition settings over time in a technically structured way. Accordingly, there is a need for an improved computer-implemented system in which a server is configured to: (i) receive and analyze attribute information and advertisement condition information from a terminal device, (ii) automatically construct and adjust prompt sentences for a generative AI model in view of advertisement format constraints, (iii) coherently generate and manage both advertisement text and advertisement image data as an integrated advertisement creative, and (iv) use advertisement delivery result information from an external distribution platform to provide feedback that technically optimizes subsequent prompt sentences and advertisement condition settings. Such a system can improve the functioning of the server as a specialized advertising generation and management platform, reduce redundant network and processing cycles, and provide a technically efficient, one-stop pipeline from ad creation to submission.

The specific processing by the specific processing unit 290 of the data processing device 12 in Example 2 is realized by the following means.

The present invention provides a server comprising a processor configured to receive, from a terminal device, attribute information and advertisement condition information regarding an advertisement target item; analyze the attribute information and the advertisement condition information to extract characteristics and appeal elements of the advertisement target item; generate, based on an extraction result and the advertisement condition information, a prompt sentence for instructing a generative AI model to generate an advertisement text; input the prompt sentence into the generative AI model to cause the generative AI model to generate the advertisement text; and transmit the generated advertisement text to the terminal device so that display and editing of the advertisement text are executable on the terminal device, the processor being further configured to obtain, based on the advertisement condition information, a character-count constraint and a component-structure constraint corresponding to an advertisement format, and adjust a length and a structure of the prompt sentence and the generated advertisement text so as to satisfy the character-count constraint and the component-structure constraint, the processor being further configured to generate, based on the characteristics and the appeal elements of the advertisement target item, an image-generation prompt sentence for input to an image-generative AI model, cause the image-generative AI model to generate advertisement image data based on the image-generation prompt sentence, associate the advertisement text and the advertisement image data with one another to form an advertisement creative, and manage the advertisement text and the advertisement image data in an integrated manner while providing, to the terminal device, advertisement management screen data that enables execution of a submission process for transmitting the advertisement creative to an external distribution platform, and the processor being further configured to acquire advertisement delivery result information from the external distribution platform, calculate an effectiveness index of the advertisement creative based on the advertisement delivery result information, and generate feedback information that includes an improvement proposal for the prompt sentence and for settings of the advertisement condition information in accordance with the effectiveness index. This enables the server to technically optimize generation and management of advertisement creatives by automatically constructing and adjusting prompt sentences and corresponding advertisement texts and images under format constraints, by maintaining integrated control over advertisement creatives and submission workflows to external distribution platforms, and by implementing a feedback loop based on delivery result information that improves subsequent advertisement generation and reduces redundant processing and network traffic in a computer-implemented advertising environment.

The term “processor” refers to a hardware and/or software based information processing unit, such as a central processing unit, a graphics processing unit, or a combination of such units with program code, that executes instructions to perform the functions described in the claims.

The term “terminal device” refers to an end-user computing apparatus, such as a smartphone, a tablet device, or a personal computer, that communicates with the server over a communication network and provides a user interface for inputting and displaying advertisement-related information.

The term “attribute information” refers to digital data representing properties, features, or characteristics of an advertisement target item, including, for example, quality attributes, functional attributes, price-related attributes, or usage attributes, that are input by a user through the terminal device.

The term “advertisement condition information” refers to digital data specifying conditions under which an advertisement is to be generated or delivered, including, for example, an advertisement format, character-count constraints, target audience settings, tone settings, delivery channels, or scheduling conditions.

The term “advertisement target item” refers to a subject of an advertisement, such as a product, a service, or a group of products or services, about which advertisement content is generated by the system.

The term “characteristics” refers to feature elements of the advertisement target item, such as performance attributes, quality indicators, or usage benefits, which are extracted from the attribute information by analysis processing of the processor.

The term “appeal elements” refers to persuasive aspects, selling points, or emphasis points of the advertisement target item, which are identified from the attribute information and advertisement condition information for use in advertisement content generation.

The term “prompt sentence” refers to a machine-readable natural language instruction text that is constructed by the processor and provided as input to a generative AI model to condition or control generation of advertisement text.

The term “generative AI model” refers to a trained information processing model, such as a large language model implemented by machine learning techniques, that generates text data in response to an input prompt sentence.

The term “advertisement text” refers to textual content, such as a headline, a body text, or a call-to-action sentence, that is generated by the generative AI model under control of the processor for use in an advertisement.

The term “advertisement format” refers to a structural specification of an advertisement, such as a type of media placement or layout pattern, including definitions of components and constraints such as headline length, body text length, image usage, or display size.

The term “character-count constraint” refers to a numerical limit or range specifying a maximum or minimum number of characters permitted for at least part of the advertisement text in accordance with an advertisement format or platform requirement.

The term “component-structure constraint” refers to a rule set specifying a required composition, order, presence, or absence of particular components, such as headline, body, and call-to-action, within the advertisement text or advertisement creative.

The term “image-generation prompt sentence” refers to a machine-readable natural language instruction text generated by the processor and provided as input to an image-generative AI model to condition or control generation of advertisement image data.

The term “image-generative AI model” refers to a trained information processing model, such as a neural network based image synthesis model, that generates image data in response to an input image-generation prompt sentence.

The term “advertisement image data” refers to digital image information, such as raster image data or vector image data, generated by the image-generative AI model for use as a visual component of an advertisement.

The term “advertisement creative” refers to a combined digital creative object comprising at least advertisement text and advertisement image data, and optionally additional metadata, that is prepared for submission to an external distribution platform.

The term “advertisement management screen data” refers to user interface data generated by the processor and transmitted to the terminal device, the user interface data enabling display of, and interaction with, advertisement text, advertisement image data, and submission controls in a unified management screen.

The term “external distribution platform” refers to an external computing system or service that receives advertisement creatives from the server and performs advertisement delivery or display to end viewers, such as an online advertising network or a digital content distribution service.

The term “advertisement delivery result information” refers to performance-related data obtained from the external distribution platform, such as impression counts, click counts, conversion counts, or other metrics indicating effectiveness of delivered advertisement creatives.

The term “effectiveness index” refers to a quantitative or qualitative metric calculated by the processor based on advertisement delivery result information, the metric representing an evaluation of performance or effectiveness of an advertisement creative.

The term “feedback information” refers to information generated by the processor based on the effectiveness index, the information including at least an improvement proposal for a prompt sentence or for advertisement condition information settings to enhance future advertisement generation.

In one embodiment, a server, one or more terminals, and a communication network cooperate to implement a system that generates, manages, and submits advertisement creatives using a generative AI model and an image-generative AI model. The server comprises at least one processor, a memory storing program instructions and data structures, a network interface, and optionally one or more hardware accelerators such as graphics processing units. The terminal comprises a processor, a display, an input device, and a network interface. The user operates the terminal to provide attribute information and advertisement condition information to the server and to review and edit generated advertisement content.

The server executes program instructions stored in the memory to perform the functions described below. The server may use an operating system such as a general-purpose server operating system, a web server such as a general HTTP server, and an application framework such as a server-side web framework. The server may use a database management system such as a relational database system and may use machine learning libraries such as numerical computation libraries and neural network frameworks. The server may also access an external generative AI model service or may execute a locally hosted generative AI model implemented using a neural network framework.

The server maintains data structures that represent attribute information, advertisement condition information, extracted characteristics, extracted appeal elements, prompt sentences, advertisement text, advertisement image data, advertisement creatives, and advertisement delivery result information. For example, the server stores, in the memory or in a persistent storage device, records that include fields such as a user identifier, an advertisement request identifier, a list of attribute tokens, a set of constraint parameters, and a link to creative assets. The server may use structured data such as tables and typed objects to manage these records.

The user operates the terminal to access a web application or native application provided by the server. The terminal executes a browser or an application runtime and renders user interface components that are defined by markup and scripts received from the server. The terminal displays input fields for attribute information and advertisement condition information, such as product features, selling points, target audience, tone, and advertisement format. The user enters, for example, “low calorie,” “organic ingredients,” and “affordable price” as attribute information, and selects “social media post, maximum 80 characters, friendly tone” as advertisement condition information. The terminal packages these values into a structured request and sends the request to the server via a network protocol such as HTTPS.

The server receives the input and stores the attribute information and advertisement condition information in the database. The server then performs text analysis using software modules implemented, for example, in a scripting or compiled language in combination with a natural language processing library such as a tokenizer, part-of-speech tagger, and named-entity recognizer. The server converts the free-form attribute information into a token sequence, identifies multi-word expressions, and maps tokens to canonical feature labels. The server may use a dictionary of synonyms and a rule-based pattern matcher to normalize variants such as “cheap,” “budget-friendly,” and “affordable” into a single canonical feature “affordable price.”

The server converts the attribute information and advertisement condition information into an internal feature representation, for example a key-value mapping that groups features under categories such as “health,” “quality,” and “price.” The server also reads advertisement format information, including character-count constraints and component-structure constraints, from a configuration store. For example, the server may obtain a rule that a particular format requires a headline of no more than 30 characters and a body of no more than 70 characters, with a required call-to-action phrase.

The server generates a prompt sentence for a generative AI model based on the feature representation and the constraints. The server uses a template engine to combine fixed instruction segments with variable segments corresponding to extracted characteristics, appeal elements, tone, target audience, and length constraints. In one example, the server generates a prompt sentence as follows:
“You are a professional advertising copywriter. Please generate a single social media advertising message for a product that is low calorie, organic, and offered at an affordable price. The target audience is health-conscious adults. Use a friendly, positive tone. Keep the entire message within 80 characters, and include a clear call-to-action. Do not use hashtags or emojis.”

In another example, the server generates a prompt sentence that includes more detailed structure constraints:
“Generate an advertising headline and a one-sentence body for a display advertisement that promotes a sugar-free, premium-quality item suitable for individuals with dietary restrictions. The target audience is health-conscious adults in their 30s and 40s. Keep the headline within 30 characters and the body within 70 characters, and include a clear call-to-action. Use a trustworthy and informative tone.”

The server may also generate an image-generation prompt sentence for an image-generative AI model. For example, the server generates:
“Create a clean, modern advertisement image for a low-calorie, organic food item at an affordable price. Use fresh green and white colors, show the item in the center, and leave space at the top for a short text headline.”

The server transmits the prompt sentence for text generation to a generative AI model. In one embodiment, the generative AI model is a large language model implemented as a deep neural network having a transformer architecture with multiple layers of self-attention and feed-forward sublayers. The model may be pre-trained on a large corpus of text using an unsupervised learning objective such as next-token prediction. The model parameters, including weight matrices in attention heads and feed-forward layers, are optimized using gradient-based learning with a loss function such as cross-entropy. The model may be fine-tuned on a domain-specific corpus of advertisement texts using supervised learning to improve stylistic conformity and factual consistency.

The server may host the generative AI model locally on a machine equipped with one or more graphics processing units and a neural network runtime, or may access an external model service over the network. In both cases, the server packages the prompt sentence and inference parameters such as temperature, maximum token count, and sampling parameters, and sends them to an inference engine. The inference engine executes matrix multiplications and non-linear activation operations across the layers of the neural network to compute probability distributions over possible next tokens, iteratively sampling or selecting tokens to form the advertisement text. The server receives the generated token sequence and decodes it into a text string.

The server applies post-processing to the advertisement text. The server counts characters according to the character encoding used by the terminal and truncates or reflows text segments when the generated text slightly exceeds the configured limits. The server may enforce component-structure constraints by splitting the text into headline, body, and call-to-action segments using delimiter patterns or by instructing the generative AI model to output explicit segment markers. The server may run a content moderation filter that checks the text against prohibited term lists and pattern-based rules to avoid disallowed language or claims.

The server transmits the advertisement text to the terminal in a response that also includes metadata such as character counts and constraint satisfaction indicators. The terminal displays the advertisement text in an editable field, shows the counts, and highlights any parts that are close to length limits. The user can modify the text and may request regeneration with adjusted conditions. When the user changes tone or target audience, the terminal sends updated parameters to the server, and the server regenerates a new prompt sentence and reruns inference as described above.

The server uses a similar but specialized process for the image-generative AI model. The server constructs an image-generation prompt sentence and sends it to a neural network-based image generator, such as a model using a diffusion architecture. In such a model, the server provides conditioning text vectors obtained by encoding the prompt sentence through a text encoder network, and the image generator iteratively denoises a random noise vector in a latent space according to a diffusion process guided by the text condition. The diffusion model parameters are trained beforehand using a loss function such as mean squared error between predicted and true noise, with optimization performed by stochastic gradient descent or a variant. The server receives the output as an image tensor and converts it to a standard raster image format.

The server stores the advertisement text and advertisement image data together with identifiers, timestamps, and linkage information to form an advertisement creative. The server may use an object storage service or a file system for image data, and a relational table for creative metadata. The server maintains associations between text segments and image identifiers in the database so that an external distribution platform can correctly retrieve both elements.

The server provides advertisement management screen data to the terminal. The server generates markup and script data that describe a unified dashboard where the user can see the advertisement text, preview the image, and initiate submission to external platforms. The terminal renders this dashboard and allows the user to confirm the creative. When the user issues a submission command, the terminal sends a request to the server, and the server maps internal creative fields to the input schema of an external distribution platform. The server may communicate with the external platform via an application programming interface using authenticated network calls.

The server further acquires advertisement delivery result information from the external distribution platform. This information includes metrics such as impressions, clicks, and conversions. The server stores the metrics in a performance table keyed by creative identifier and time window. The server computes effectiveness indices such as click-through rate or conversion rate, possibly normalized by audience segment or format. The server then analyzes the relationship between feature representations (such as which characteristics and appeal elements were included in the prompt sentence) and the effectiveness indices.

The server uses this relationship to generate feedback information and to refine subsequent prompt sentences. The server may implement a learning module that adjusts weightings assigned to particular features when constructing prompt sentences. For example, the server may maintain a vector of feature importance scores that is updated using a gradient-based or bandit-style optimization algorithm based on observed effectiveness indices. If certain appeal elements consistently yield higher click-through rates for a given audience and format, the server increases their weight and places them earlier or with stronger emphasis in subsequent prompt sentences. This processing changes the internal data structures and constraint parameters such that, over time, the server selects and orders features in a way that is optimized for the computing environment of the external distribution platforms.

The server thus implements more than a simple automation of human copywriting. The server performs a structured transformation of attribute information and advertisement condition information into machine-optimized prompt sentences under explicit computational constraints. This transformation uses algorithmic steps that are non-trivial for human operators, such as dynamic constraint satisfaction, feature normalization across large datasets, and ongoing optimization based on quantitative feedback. By encoding feature importance and constraint-handling strategies within the server's data structures and algorithms, the system reduces the number of iterations and the volume of data transmitted between the server, the generative AI model, and the external distribution platform. As a result, the server reduces network traffic, shortens processing time for generating acceptable creatives, and improves storage coherence by managing text and image assets as unified advertisement creatives.

In another embodiment, the server hosts the generative AI model locally rather than calling an external service. In this case, the server includes a dedicated accelerator, such as a GPU or tensor processing unit, and a model runtime. The server loads model parameters from a model store into the accelerator memory and executes inference directly. The server may use mixed-precision arithmetic to reduce memory bandwidth and computation time and may batch prompts to process multiple requests concurrently. These optimizations constitute specific improvements to computer technology in terms of computation efficiency and resource utilization.

In a further embodiment, the server uses different generative AI models for different advertisement formats. For short text formats, the server may select a smaller model with fewer transformer layers, whereas for long-form formats, the server may select a larger model with improved context handling. The server stores mapping rules from formats to models and uses these rules to allocate computational resources appropriately. This design reduces latency for short messages and avoids overuse of computationally expensive models when not needed, thereby improving overall throughput of the advertising generation system.

In another variation, the server augments prompt sentence construction with rule-based transformations that are not conventionally applied by human operators. For example, the server may enforce consistent syntactic patterns that maximize readability on small screens, or may suppress certain phrase structures known to cause truncation in specific display environments. These rules are applied systematically by the server based on device profiles and platform specifications stored in configuration data. Because the server uses exact character and pixel dimension calculations, the server can preemptively prevent layout errors that might otherwise occur only at rendering time.

The terminal remains relatively simple in comparison to the server but plays an important role in the overall operation. The terminal renders user interface elements according to the data received from the server, provides fields for user edits, and sends user modifications back to the server. The terminal may also cache certain configuration data to reduce network traffic and improve responsiveness. However, the core analysis, prompt sentence construction, generative AI model interaction, and creative management are all performed by the server, ensuring that improvements in processing algorithms and model integrations can be deployed centrally.

Through these embodiments and variations, the server cooperates with the terminal and the user to implement a concrete, technically oriented system. The system improves processing speed and accuracy for advertisement content generation and reduces resource usage by tailoring generative AI model calls and prompt sentences to explicit computational constraints and feedback-driven optimization. The generative AI model and the image-generative AI model are not treated as black boxes; instead, the server uses structured feature representations, constraint-aware prompt sentence construction, and feedback-based parameter adjustments to improve the functioning of the advertising generation platform as a whole.

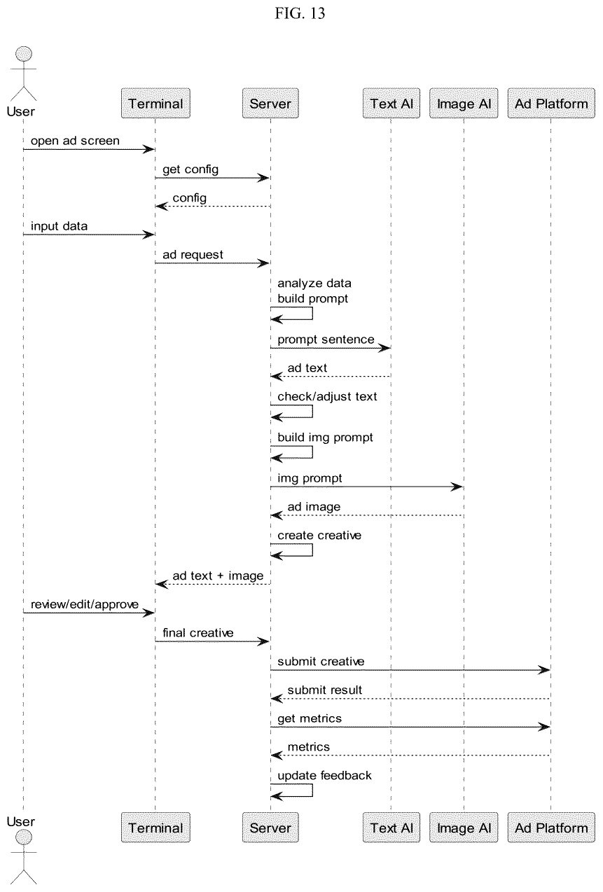

The following describes the processing flow using FIG. 13.

### Step 1:

The user operates the terminal to open an advertisement creation screen. The terminal sends a configuration request to the server and receives available advertisement formats and constraints as a response.

Input: No prior input from the user; the terminal sends a format/configuration request to the server. Output: The terminal receives configuration data such as available advertisement formats, character-count limits, and component-structure information from the server.

The terminal parses the configuration data and renders input fields (for product attributes, selling points, target audience, tone, and format selection) on a display for the user.

### Step 2:

The user operates the terminal to input attribute information and advertisement condition information. The terminal collects text strings and selection values entered by the user. Input: User-entered attribute information such as “low calorie,” “organic ingredients,” “affordable price,” and condition information such as “social media post,” “max 80 characters,” and “friendly tone.”

Output: The terminal constructs a structured request including fields for attribute information and advertisement condition information and prepares it for transmission.

The terminal performs local validation on required fields (e.g., non-empty checks) and converts human-readable selections into internal identifiers for formats, tones, and target audiences. Step 3:

The terminal sends the structured request to the server via a network interface using a secure protocol.

Input: A structured representation of user inputs, including attribute information, advertisement condition information, and user identification data.

Output: The server receives a network message containing the structured request and stores the raw data in a request record.

The terminal encodes the request as a message, attaches authentication data, and transmits it; the server decodes the message, verifies authentication, and writes the request into a persistent storage system.

### Step 4:

The server analyzes the attribute information to extract characteristics and appeal elements. Input: Raw attribute information and advertisement condition information from the stored request record.

Output: A normalized feature representation that categorizes the attribute information into structured features such as health-related, quality-related, and price-related attributes.

The server tokenizes the attribute text into word tokens, identifies multi-word terms such as “low calorie” and “organic ingredients,” and uses synonym dictionaries and rule-based mappings to convert raw phrases into canonical features. The server groups features into categories and builds a key-value structure that maps categories (for example, “health”) to lists of features (for example, [“low calorie”]).

### Step 5:

The server determines applicable advertisement constraints based on the advertisement format. Input: Advertisement condition information including a selected format identifier, and a configuration data set defining constraints for each format.

Output: A constraint parameter set specifying character-count constraints and component-structure constraints, such as maximum characters for headline and body and required presence of a call-to-action.

The server looks up the format identifier in a configuration table, retrieves the constraints, and merges them with user preferences (such as tone and target audience) to create a combined constraint profile used in subsequent processing.

### Step 6:

The server constructs a prompt sentence for a generative AI model using the feature representation and constraints.

Input: The normalized feature representation (characteristics and appeal elements) and the constraint parameter set.

Output: A prompt sentence in natural language that instructs the generative AI model how to generate advertisement text.

The server uses a template engine to join fixed instruction segments (“You are a professional advertising copywriter.”) with variable parts derived from the feature representation (“low calorie, organic, affordable”) and constraints (“within 80 characters,” “include a clear call-to-action,” “friendly tone”). The server assembles the complete prompt as a string and stores it in association with the request.

### Step 7:

The server sends the prompt sentence to the generative AI model and obtains generated advertisement text.

Input: The constructed prompt sentence and model inference parameters such as temperature, maximum token count, and sampling strategy.

Output: Generated advertisement text that reflects the characteristics and appeal elements under the specified constraints.

The server transmits the prompt sentence and parameters to a generative AI model implemented as a transformer-based neural network. The model processes the prompt token-by-token, computing attention-based weighted sums and applying non-linear transformations to produce probability distributions over possible next tokens. The server sequentially samples or selects tokens from these distributions to form a text output, then decodes token identifiers to characters, producing an advertisement text string.

### Step 8:

The server post-processes the generated advertisement text to enforce constraints and filter content. Input: Raw generated advertisement text and the constraint parameter set including character-count and component-structure constraints.

Output: A validated and possibly adjusted advertisement text that satisfies length restrictions, structural requirements, and content rules.

The server counts characters in the generated text, trims or splits the text to meet the maximum lengths while preserving word boundaries, and optionally segments headline and body based on punctuation or markers. The server runs the text through rule-based filters to detect prohibited terms or formats; if violations are detected, the server either regenerates text with a modified prompt or flags the issue. The server stores the validated text as an advertisement text record.

### Step 9:

The server generates an image-generation prompt sentence for an image-generative AI model. Input: The normalized feature representation, advertisement condition information, and, optionally, the generated advertisement text.

Output: An image-generation prompt sentence that specifies visual characteristics for advertisement image data.

The server selects visual attributes (for example, “fresh green and white colors,” “product in the center,” “space for a headline”) based on the product features and format. The server composes them into a natural language description that an image-generative AI model can interpret, and stores this prompt for use in image generation.

### Step 10:

The server sends the image-generation prompt sentence to the image-generative AI model and obtains advertisement image data.

Input: The image-generation prompt sentence and image generation parameters such as resolution, aspect ratio, and sampling steps.

Output: Generated advertisement image data in a digital image format.

The server passes the text prompt to an image-generative model such as a diffusion-based neural network. The model converts the prompt into an embedding vector via a text encoder and iteratively refines a noise image tensor through a denoising process guided by the embedding. The server receives the resulting image tensor, encodes it into a standard image format (for example, PNG or JPEG), and stores it in an image repository, along with an identifier.

### Step 11:

The server forms an advertisement creative by associating the advertisement text and the advertisement image data.

Input: The validated advertisement text record and the stored advertisement image identifier. Output: A composite advertisement creative record that includes references to both text and image and accompanying metadata.

The server creates or updates a creative data structure that links the text, the image, the request identifier, and the applicable format. The server computes and stores metadata such as asset sizes and aspect ratios to facilitate correct rendering on external platforms.

### Step 12:

The server generates advertisement management screen data and transmits it to the terminal.

Input: The advertisement creative record and configuration data for user interface elements.

Output: User interface data that, when rendered on the terminal, displays the advertisement text and image and allows user actions such as editing and submission.

The server prepares a response that contains layout instructions, text content, and image references, and sends it to the terminal. The terminal decodes the response and renders a management screen where the user can see the generated advertisement creative.

### Step 13:

The user operates the terminal to review and optionally edit the generated advertisement text and image association.

Input: The displayed advertisement text and image on the terminal's screen.

Output: Either an updated set of advertisement text and condition parameters or a confirmation to proceed with submission.

The user reads the text, may replace phrases or adjust tone directly in the editable fields, and may request alternate generations by selecting different constraints. The terminal collects these edits and sends them back to the server as updated parameters, or sends a confirmation message indicating that the current creative is approved.

### Step 14:

The server processes user edits or approval and finalizes the advertisement creative.

Input: User-edited advertisement text, adjusted condition parameters, or an approval signal received from the terminal.

Output: A finalized version of the advertisement creative ready for submission, or a regenerated creative if new text generation is requested.

The server overwrites prior text with the user-edited version or regenerates text using a new prompt sentence, then updates the creative record. When approval is received, the server marks the creative as ready for submission and adds or updates campaign-related metadata such as budget and schedule if provided.

### Step 15:

The server submits the finalized advertisement creative to an external distribution platform.

Input: The finalized advertisement creative record and platform-specific configuration information such as authentication tokens and field mappings.

Output: A submission result from the external distribution platform, including success or error information.

The server maps internal fields (headline, body, image URL, call-to-action) to the external platform's API parameters, constructs a platform-specific request, and sends the creative data over a network. The server receives a response indicating whether the submission succeeded and stores status codes and messages in a submission log.

### Step 16:

The server acquires advertisement delivery result information from the external distribution platform and updates its performance data.

Input: Delivery metrics such as impressions, clicks, and conversions retrieved via the platform's reporting interface.

Output: Updated performance records and one or more effectiveness indices for the advertisement creative.

The server periodically calls reporting functions of the external platform, parses returned metrics, and inserts or updates records associated with the creative. The server computes indices such as click-through rate by dividing clicks by impressions and may segment metrics by time or audience.

### Step 17:

The server generates feedback information and adjusts internal parameters used for constructing future prompt sentences.

Input: Performance records and effectiveness indices for past advertisement creatives.

Output: Updated feature importance values and feedback data that influence subsequent prompt sentence construction.

The server analyzes correlations between characteristics and appeal elements used in previous prompt sentences and the resulting effectiveness indices. The server adjusts weight values for features and constraint parameters using optimization algorithms, and generates feedback text that suggests, for example, emphasizing certain health-related features. This updated information is stored and used as input in future executions of Steps 4 through 6 to refine the generative AI model's outputs and reduce the need for manual revision by the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented advertising systems typically separate text generation, image generation, user interaction, and performance analysis into isolated components or external tools. In such systems, a server often receives manually authored advertising messages and static image assets from a user terminal, and merely stores, formats, and forwards those assets to external advertising platforms. As a result, the core computation on the server side is limited to simple input/output and formatting logic, and does not effectively leverage machine learning models to dynamically adapt advertising content.

In particular, when using a generative AI model, many existing approaches treat the model as a black-box text or image generator that is invoked with manually composed prompt sentences. A processor in such systems typically does not perform structured pre-processing of product attributes and display format constraints, and does not systematically construct or update prompt sentences for the generative AI model based on machine-readable, fine-grained state. This leads to several technical issues: (i) the server cannot consistently generate advertising text that conforms to strict length and layout constraints of heterogeneous media formats; (ii) the server cannot efficiently reuse and manage prompt sentences and generated content in association with performance metrics; and (iii) the server cannot dynamically adapt the prompt sentences or generated outputs in real time based on user state information such as emotion or behavior history.

Furthermore, in conventional architectures, emotional information or user behavior history, when used at all, is processed only at the client side or as a post-processing filter. The server is not architected to integrate such user state information as a first-class input into the generative pipeline. Consequently, the server cannot modify the generation conditions of the generative AI model itself in response to changing user states, and instead must rely on static templates or manual editing by the user, which increases the processing load on the user device and causes delays in content adaptation.

Additionally, known systems that analyze advertisement performance often compute simple aggregate metrics and present them to the user without feeding them back into the prompt-generation logic. In such systems, the processor does not correlate each prompt sentence and each generated text or image with corresponding distribution result information, and does not update internal generation conditions in a learning manner. This prevents the server from improving the effectiveness of later generations and requires manual trial-and-error adjustments, which is computationally inefficient and leads to suboptimal utilization of the generative AI model. Therefore, there is a need for a computer-implemented system in which a processor manages structured product attributes, appeal conditions, and format constraints; automatically constructs and updates prompt sentences for text and image generative AI models; integrates user state information such as emotion and behavior history into the prompt-generation and regeneration pipeline; and stores and analyzes performance data in association with prompt sentences and generated content to improve subsequent generations. Such a system should improve the functioning of the server itself by enabling more efficient orchestration of multiple AI models, more precise control of generated outputs with respect to media constraints, and adaptive, real-time generation of optimized advertising content with reduced manual intervention on the user device.

The specific processing by the specific processing unit 290 of the data processing device 12 in Application Example 2 is realized by the following means.

The present invention provides a server comprising a processor configured to receive, from a user device, attribute information of an advertising target, appeal conditions, and display format information, convert the attribute information and the appeal conditions into structured data, generate, based on the structured data and the display format information, a first prompt sentence including a character length constraint and an expression condition and cause an external generative AI model to generate advertising text information by inputting the first prompt sentence into the external generative AI model, generate, based on the advertising text information and the attribute information, a second prompt sentence including a visual expression condition and cause an external image generative AI model to generate advertising image information by inputting the second prompt sentence into the external image generative AI model, perform text processing and image processing on the advertising text information and the advertising image information to generate advertising composite content conforming to a predetermined advertising medium specification, transmit the advertising composite content to the user device and update the advertising composite content in accordance with edit content received from the user device, store, in a storage device, the advertising composite content in association with the first prompt sentence and the second prompt sentence, transmit the advertising composite content to an external distribution device to execute an advertisement distribution process and acquire result information of the advertisement distribution process and accumulate the result information as analysis target data, and dynamically change at least one of the first prompt sentence, the second prompt sentence, and the advertising text information based on user state information including at least one of emotion state information and behavior history information acquired from a user state acquisition device and call the external generative AI model again to generate, in real time, advertising text information or advertising composite content optimized in accordance with the user state information. This enables the server to internally orchestrate structured pre-processing, prompt construction, multi-modal content generation, real-time regeneration based on user state, and feedback-based updating of generation conditions, thereby improving the technical functioning of the computer system by reducing manual processing at the user device, enforcing media constraints at generation time, and adaptively enhancing the effectiveness of generated advertising content through machine-driven control of prompt sentences supplied to the generative AI models.

The term “system” refers to an arrangement including at least one processor and one or more storage and communication components that cooperate to execute the functions described in the claims.

The term “processor” refers to one or more hardware computation units, such as a central processing unit or a logic circuit, configured to execute instructions to perform the data processing operations described herein.

The term “server” refers to a computing apparatus including the processor and a communication interface, configured to communicate with one or more user devices and external devices over a network.

The term “user device” refers to an information processing apparatus operated by a user, such as a terminal including a display and an input interface, configured to transmit data to and receive data from the server.

The term “attribute information of an advertising target” refers to data representing properties of goods, services, or other entities to be advertised, including at least one of category, function, feature, price range, or usage scenario.

The term “appeal conditions” refers to data representing desired emphasis points or persuasive aspects for an advertisement, including at least one of advantages, benefits, value propositions, or messages to be highlighted.

The term “display format information” refers to data defining constraints or specifications of an advertising medium, including at least one of layout type, maximum character length, aspect ratio, image size, or placement of text.

The term “structured data” refers to data organized according to a predefined schema or format, such as key-value pairs, records, or objects, enabling systematic computational processing by the processor.

The term “prompt sentence” refers to a text string that encodes instructions, constraints, or context supplied to a generative AI model to control or guide generation of output content.

The term “first prompt sentence” refers to a prompt sentence generated based on structured data and display format information, including at least a character length constraint and an expression condition, and supplied to a text generative AI model.

The term “second prompt sentence” refers to a prompt sentence generated based on advertising text information and attribute information, including at least a visual expression condition, and supplied to an image generative AI model.

The term “character length constraint” refers to a restriction specifying a maximum or target number of characters for text to be generated by a generative AI model.

The term “expression condition” refers to a parameter specifying one or more stylistic or semantic requirements for generated text, including at least one of tone, formality level, sentence structure, or inclusion of specified terms.

The term “visual expression condition” refers to a parameter specifying one or more visual requirements for generated image content, including at least one of scene type, object type, color scheme, composition, or style.

The term “generative AI model” refers to a machine learning model configured to generate output data, such as text or images, based on input data including prompt sentences and optional parameters.

The term “external generative AI model” refers to a generative AI model executed on a device or service distinct from the server, which is accessed by the server through a communication interface.

The term “image generative AI model” refers to a generative AI model configured to generate image data based on input prompt sentences and optional conditions.

The term “advertising text information” refers to text data representing at least one advertising message generated by a text generative AI model or derived therefrom.

The term “advertising image information” refers to image data representing at least one advertising visual generated by an image generative AI model or derived therefrom.

The term “text processing” refers to computation performed on text data, including at least one of truncation, formatting, filtering, tokenization, or modification of wording.

The term “image processing” refers to computation performed on image data, including at least one of resizing, cropping, compression, overlaying of text, or color adjustment.

The term “advertising composite content” refers to content including at least one combination of advertising text information and advertising image information, arranged to satisfy constraints of a predetermined advertising medium specification.

The term “predetermined advertising medium specification” refers to a set of constraints corresponding to requirements of an advertising channel, including at least one of content size, aspect ratio, file format, text position, or allowed character count.

The term “edit content” refers to data representing modifications or confirmations of advertising composite content supplied from the user device, including at least one of edited text, selection of images, or approval input.

The term “storage device” refers to a non-transitory computer-readable storage medium or a storage subsystem configured to store data such as prompt sentences, generated content, and result information.

The term “external distribution device” refers to an external computing system or service that receives advertising composite content from the server and performs delivery or display of advertisements to end users.

The term “advertisement distribution process” refers to a sequence of operations by which advertising composite content is transmitted, scheduled, and presented to end users via one or more distribution channels.

The term “result information of the advertisement distribution process” refers to data representing performance of distributed advertisements, including at least one of impressions, click counts, conversion counts, or engagement metrics.

The term “analysis target data” refers to result information and related data stored for use in analysis operations that evaluate or optimize advertising performance.

The term “user state information” refers to data representing a current or past state of a user, including at least one of emotion state information and behavior history information.

The term “emotion state information” refers to data indicating an estimated emotional condition of a user, such as joy, sadness, anxiety, or neutrality, derived from at least one of sensor data, biometric data, or behavioral data.

The term “behavior history information” refers to data indicating past actions of a user, including at least one of browsing history, interaction history with advertisements, purchase history, or content viewing patterns.

The term “user state acquisition device” refers to a device or subsystem configured to measure, estimate, or retrieve user state information, including at least one of a sensor-equipped user device, a sensing module, or a behavior logging system.

The term “response index” refers to a numerical or categorical value representing a measure of reaction to advertising content, computed based on result information of the advertisement distribution process.

The term “prompt generation conditions” refers to parameters or rules used by the processor when constructing prompt sentences, including at least one of required keywords, tone settings, length constraints, and content selection criteria.

The term “call conditions of the external generative AI model” refers to operational parameters used when invoking the external generative AI model, including at least one of model type, sampling parameters, frequency of invocation, or number of generated candidates.

The term “evaluation information” refers to data presented to the user device that summarizes or interprets analysis results, including at least one of performance summaries, rankings, or suggested actions.

The term “advertisement improvement policy” refers to an instruction or guideline for modifying future advertising content, derived from analysis of result information and response indexes.

The term “recommended setting” refers to at least one suggested configuration parameter, such as a prompt generation condition, a distribution parameter, or a content selection preference, proposed to improve advertising performance.

In one embodiment, a server provides a computer-implemented system that generates, optimizes, and delivers advertising content by coordinating structured prompt sentence generation, multi-modal generative AI models, and feedback-based adaptation using performance data and user state information.

### A. Hardware and Software Configuration

The server includes at least one processor, a main memory, a non-transitory storage device, and a network interface. The processor executes programs stored in the storage device and main memory. The storage device may be implemented by a magnetic disk device, a solid-state drive, or a network-attached storage system. The network interface connects the server to a communication network, such as the Internet, and communicates with one or more terminals and external computing systems. The server executes a server-side application implemented, for example, using a general-purpose programming language (e.g., a language interpreter or runtime) and a web application framework. The server uses natural language processing libraries such as a tokenization and parsing library, a neural network framework such as a tensor computation library (for example, implementing a multi-layer neural network), and an image processing library such as a pixel-based image manipulation library. The server accesses external generative AI models through API clients; the generative AI models may be text generation models and image generation models deployed on cloud-based AI platforms or on dedicated GPU hardware.

The terminal includes a processor, a memory, a display unit, a user input unit (such as a touch panel, keyboard, or pointing device), and optionally one or more sensors such as a camera and a microphone. The terminal executes a browser application or a native application providing a user interface for advertising creation and review. The terminal communicates with the server via the communication network using a secure transport protocol.

### B. Data Structures

The server uses specific data structures to represent input information, intermediate representations, prompt sentences, and generated content.

The server stores attribute information of an advertising target as structured records, each including fields such as “category”, “feature”, “usage scenario”, and “price range”. The server stores appeal conditions as structured records including fields such as “advantage keyword”, “benefit description”, “tone constraint”, and “target audience”. The server stores display format information as structured records defining fields such as “ad_channel”, “max_characters”, “aspect_ratio”, “image_width”, “image_height”, and “text_position_region”.

The server converts these records into structured data objects used by the prompt generation module. In one implementation, the server internally represents such objects as key-value maps indexed by identifiers of products, campaigns, or creatives. This representation allows the processor to efficiently access and update individual features when constructing or revising a prompt sentence. The server stores each prompt sentence as a text field associated with metadata in a prompt table. The metadata includes identifiers of the target product, the generative AI model type (text or image), the model configuration parameters used at generation time, and version information. The server stores advertising text information and advertising image information in separate tables linked via foreign keys to their corresponding prompt sentences.

The server stores result information of an advertisement distribution process as time-series records. Each record associates a creative identifier with distribution channel identifiers, timestamps, and metrics such as impression count, click count, and conversion count. The server computes a response index from these metrics and stores the index as a numerical feature used in later learning and optimization.

### C. Generative AI Model Structure

The server uses a text generative AI model that is implemented as a transformer-based neural network. The model includes a stack of self-attention layers and feed-forward layers. Each self-attention layer receives token embeddings and applies scaled dot-product attention across all tokens, followed by layer normalization and a position-wise feed-forward network. The model is trained on large-scale text data to predict the next token given a sequence of previous tokens.

The server configures the text generative AI model with parameters including vocabulary size, embedding dimension, number of attention heads, number of layers, maximum context length, and sampling parameters such as temperature and nucleus sampling probability. The model uses a cross-entropy loss function during training, and training is performed using stochastic gradient descent or a variant thereof, with adaptive learning rate and weight decay. The weights are updated by backpropagating the error between the predicted token probabilities and ground-truth tokens. The server uses an image generative AI model that is implemented as a diffusion-based neural network or a generative adversarial network. In a diffusion-based implementation, the model uses a U-Net architecture that denoises images across multiple timesteps conditioned on a text embedding derived from a prompt sentence. The model is trained to predict noise added to training images under a known noise schedule, using a mean-squared error loss between predicted noise and actual noise. In a generative adversarial implementation, the model includes a generator network and a discriminator network, where the generator learns to output images that the discriminator cannot distinguish from real images.

The server uses these models not as opaque components, but with explicit control of input representations and model parameters. The server selects model architectures and hyperparameters to achieve desired tradeoffs between generation speed and quality, and exposes these settings as part of the system configuration.

### D. Prompt Sentence Generation and Control

The server implements a prompt generation module as a dedicated software component executed by the processor. The module receives structured data representing attribute information, appeal conditions, and display format information, and outputs one or more prompt sentences tailored for specific generative AI models.

The server uses non-trivial rules for constructing prompt sentences. Instead of simply concatenating text fields, the server assigns different weights or priorities to features. For example, the server enforces that features marked as “primary advantage” must appear in the beginning of the prompt sentence, and that constraints such as “maximum 100 characters” must be explicitly specified in the instruction segment of the prompt sentence.

In one example, the server constructs a first prompt sentence for the text generative AI model as follows:
“You are an expert ad copywriter.
Product name: SmartPhone X.
Characteristics: 108 MP high-resolution camera, 24-hour battery.
Selling point: professional-quality photos for everyday users.
Ad format: Instagram feed.
Constraint: maximum 100 characters, one sentence, highlight the camera.
Generate one ad message in English only.”

The server decomposes this prompt sentence into a role designation part (“You are an expert ad copywriter.”), a context description part (“Product name: . . . . Characteristics: . . . . Selling point: . . . . Ad format: . . . ”), and a constraint part (“Constraint: maximum 100 characters . . . ”). The server dynamically constructs these parts from structured data and merges them according to a predefined template. This structured prompt design improves the reproducibility and controllability of generated outputs compared to ad-hoc manual prompting.

The server also generates a second prompt sentence for the image generative AI model. In one example, the server creates:
“Create an Instagram feed ad image for SmartPhone X.

Show a sleek smartphone in a user's hand, capturing a vibrant city night scene with sharp details and bright colors.

Emphasize the large camera lens and professional photo quality.

Format: square 1:1, clean layout with space at the top for the tagline ‘Shoot like a pro every day.’ Style: modern, realistic, high contrast.”

The server derives this second prompt sentence by parsing the advertising text information to detect emphasized concepts (e.g., “night scene”, “sharp details”) and embedding them into the visual specification. The server also reflects display format information into explicit directives such as “square 1:1” and “space at the top”.

By converting structured data and constraints into explicitly structured prompt sentences for both text and image models, the server improves technical control over the behavior of the generative AI models. This reduces the number of regeneration cycles required to obtain content that satisfies hard display constraints, thereby reducing computation and network communication.

### E. Use of User State Information

The server receives user state information from a user state acquisition device connected to the terminal. The terminal captures facial images and voice signals using sensors and transmits feature vectors extracted by a local feature extractor to an emotion recognition engine. The emotion recognition engine may be implemented as a neural network classifier trained on labeled emotion data. The classifier outputs emotion state information including a label such as “joy”, “sadness”, or “anxiety”, and a confidence score.

The server receives this emotion state information and maps it to a set of generation modifiers. For example, the server associates “anxiety” with a requirement to include reassurance phrases and to use a calm tone, and associates “joy” with a requirement to use energetic and playful expressions. The server then modifies the first prompt sentence according to these modifiers.

In one example, when the user state information indicates anxiety, the server constructs a prompt sentence as follows:
“The user feels anxious about choosing a smartphone.
Product: SmartPhone X with a 108 MP camera and 24-hour battery.
Goal: reassure the user and reduce anxiety.
Generate a short, calm, and supportive ad message within 90 characters.”

This explicit encoding of the user state and goal within the prompt sentence allows the text generative AI model to produce content tailored to the current user emotion, without requiring the terminal to perform complex text manipulation. As another example, when the user state information indicates joy, the server constructs:
“The user feels joyful and excited.
Product: SmartPhone X with a 108 MP camera and 24-hour battery.
Goal: amplify excitement and fun.
Generate a high-energy, playful ad message within 90 characters.”

The server also modifies the second prompt sentence for the image generative AI model, for instance by specifying warmer color palettes or brighter scenes in response to joy.

By integrating user state information into prompt generation, the server provides a non-conventional, machine-controlled adaptation mechanism: instead of manual edits or simple filtering, the server reconfigures the input instructions to the generative AI models, causing the models to operate under dynamically changing constraints. This improves the alignment of generated content with user conditions while maintaining computational efficiency at the server.

### F. Performance Feedback and Learning

The server uses result information of the advertisement distribution process to compute response indexes for each prompt sentence and for each generated piece of content. The server defines a response index as a function of metrics such as click-through rate, conversion rate, and viewing time. For instance, the server may compute a weighted sum of normalized metrics, or may train a regression model to predict overall effectiveness.

The server records associations between each first prompt sentence, each second prompt sentence, each advertising text output, each advertising image output, and the corresponding response indexes. The server then uses these associations to update prompt generation conditions and call conditions of the generative AI models.

In one embodiment, the server maintains a parameter vector for prompt templates, which includes binary flags indicating whether certain instruction phrases should be included, and numeric weights indicating relative importance of features. The server updates this parameter vector using a gradient-free optimization algorithm or a reinforcement learning approach based on observed response indexes. As a result, over time the server biases prompt construction toward configurations that historically yielded higher response indexes.

Similarly, the server adjusts call conditions of the external generative AI models, such as sampling temperature, maximum token count, or number of generated candidates, based on the distribution of successful outputs. For example, if lower temperature settings consistently result in higher response indexes for a specific product category, the server automatically reduces the temperature for subsequent calls in that category.

By learning from feedback in this manner, the server improves the efficiency and quality of future generations. The system reduces the need for manual A/B testing on the user side and instead internalizes experiment and selection logic into the server's computational process. This represents a technical improvement: the server's generative pipeline becomes self-optimizing with respect to network calls, compute utilization, and content quality.

### G. Technical Effects and Improvement of Computer Functioning

The described system improves the functioning of the server and associated computing devices beyond mere automation of human tasks. By structuring input data into machine-readable objects and constructing prompt sentences that encode explicit constraints and goals, the server reduces the number of failed or non-compliant generations and therefore reduces processor load, network traffic between the server and external AI services, and storage consumption.

The server integrates user state information directly into prompt sentences, allowing real-time generation of content that would be difficult or impractical to achieve manually or with static templates. This dynamic adaptation mechanism minimizes repeated user edits, shortens the feedback loop, and reduces latency in content presentation to the terminal.

The server's use of performance feedback to adjust prompt generation conditions and model call conditions provides another technical effect. The server does not only present analytics to a user; it incorporates the analytics into internal decision logic for subsequent computations. This drives improved convergence of generation parameters, reduces variance of output quality, and enables more consistent enforcement of media constraints.

Because the server manages associations between structured data, prompt sentences, generated outputs, and performance metrics within defined data structures, it achieves efficient indexing and retrieval operations. This structured approach allows quick recombination and search of historical prompts and creatives, further reducing computational overhead when generating variations or testing new conditions.

### H. Variations and Alternative Embodiments

In another embodiment, the server may host the generative AI models locally instead of calling external services. In this case, the server uses a neural network framework deployed on GPU hardware within the server. The same prompt generation and feedback mechanisms apply, but the server can further adjust model weights using fine-tuning or continual learning techniques based on domain-specific training data and response indexes.

In yet another embodiment, the server may use different neural network architectures, such as recurrent neural networks for text generation or variational autoencoders for image generation. The essential aspect is that the server constructs and modifies prompt sentences and model parameters according to structured constraints and user state information, and that the server maintains associations between prompts, outputs, and performance data for feedback-based optimization. In a further variation, the terminal may perform some pre-processing of user input, such as local language detection or keyword extraction, and transmit partially structured data to the server. The server then completes the structuring, prompt generation, and model invocation. Alternatively, the terminal may be a specialized device such as a digital signage controller or a head-mounted display unit, and the advertising composite content may be delivered to and rendered in such devices with specific timing or interaction behavior.

These and other embodiments show that the server, the terminal, and the generative AI models cooperate according to specific data structures, algorithms, and control flows to achieve technically improved generation and delivery of advertising content, grounded in prompt sentence design, structured data handling, and feedback-driven adaptation.

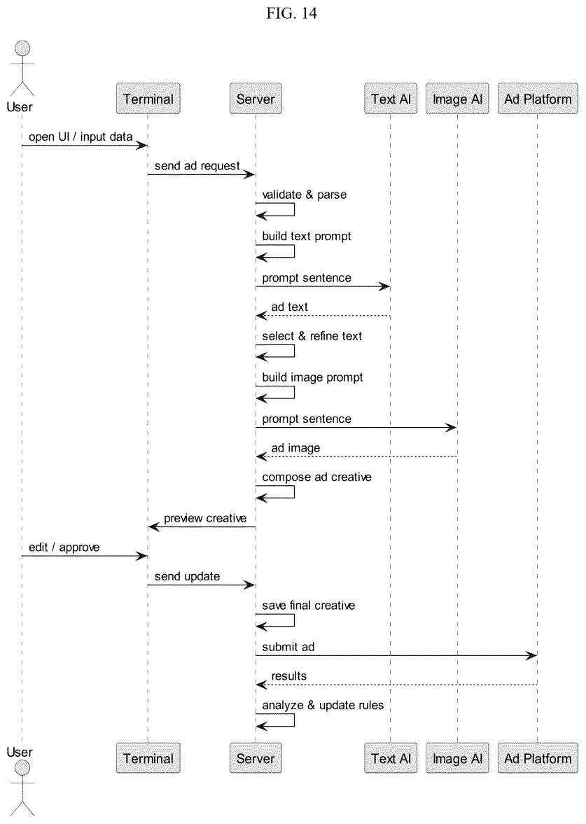

The following describes the processing flow using FIG. 14.

### Step 1:

User operates the terminal to open an advertising creation interface and input advertising target information.

User inputs, as input data, product attributes (for example, name, category, features), appeal conditions (for example, advantages, tone, target audience), and display format information (for example, ad channel, maximum characters, image size).

Terminal receives these values through UI widgets (text boxes, drop-downs, toggles) and converts them into structured internal fields. Terminal outputs a structured request object containing the input data and transmits the object to the server via a network protocol.

### Step 2:

Server receives the request object from the terminal as input and parses its fields.

Server validates the input data by checking required fields, allowed ranges, and string lengths; server also normalizes encodings and character sets.

Server performs data cleaning operations, such as trimming whitespace and removing unsupported symbols, and outputs a normalized, validated data record for further processing.

### Step 3:

Server converts the validated data record into structured data optimized for prompt generation. Server uses a natural language processing library to tokenize feature descriptions, remove stopwords, and detect key phrases (for example, “108 MP camera”, “24-hour battery”).

Server analyzes the display format information to compute constraints such as ‘max_characters’, ‘required_keywords’, and layout type.

Server aggregates the tokens, key phrases, and constraints into a structured feature vector and outputs this structured representation as input for prompt construction.

### Step 4:

Server generates a first prompt sentence for a text generative AI model based on the structured representation.

Server applies a template engine that arranges role description, context, and constraints into a single text string.

Server inserts the extracted key phrases into the “Characteristics” and “Selling point” sections and inserts numerical constraints into the “Constraint” section.

For example, server generates as output the prompt sentence:
“You are an expert ad copywriter.
Product name: SmartPhone X.
Characteristics: 108 MP high-resolution camera, 24-hour battery.
Selling point: professional-quality photos for everyday users.
Ad format: Instagram feed.
Constraint: maximum 100 characters, one sentence, highlight the camera.
Generate one ad message in English only.”

This prompt sentence becomes the input to the text generative AI model.

### Step 5:

Server calls an external text generative AI model with the first prompt sentence as input.

Server sends an API request containing the prompt sentence and generation parameters (for example, maximum token count, sampling temperature, top-p) to the generative AI model endpoint.

Server receives as output one or more generated text sequences representing candidate advertising messages.

Server parses the API response, extracts the text segments, and stores them in a temporary data structure along with metadata (prompt identifier, model identifier, timestamp).

### Step 6:

Server post-processes the generated advertising text information.

Server takes each candidate text ad as input and measures its character length; server truncates or rejects candidates that exceed the maximum character limit.

Server checks for inclusion of required keywords derived from the structured data (for example, “camera”, “battery”) and optionally runs a content safety classifier.

Server ranks candidates using a scoring function that considers keyword coverage, length conformity, and basic sentiment classification.

Server outputs a selected advertising text message that satisfies all constraints and is associated with the original prompt sentence.

### Step 7:

Server generates a second prompt sentence for an image generative AI model using the selected advertising text and attribute information as input.

Server analyzes the selected text to identify visualizable concepts (for example, “night scene”, “sharp details”) using a keyword extractor.

Server combines these concepts with display format constraints (for example, 1:1 aspect ratio, reserved text region) into a visual instruction template.

Server constructs as output an image-oriented prompt sentence, for example:
“Create an Instagram feed ad image for SmartPhone X.
Show a sleek smartphone in a user's hand, capturing a vibrant city night scene with sharp details and bright colors.
Emphasize the large camera lens and professional photo quality.
Format: square 1:1, clean layout with space at the top for the tagline ‘Shoot like a pro every day.’ Style: modern, realistic, high contrast.”

### Step 8:

Server calls an external image generative AI model with the second prompt sentence as input. Server sends an API request specifying the prompt sentence, output resolution, and number of images to generate.

Server receives, as output, one or more image objects or image binaries generated by the image generative AI model.

Server decodes the image data, verifies image dimensions and file format, and stores intermediate image objects in memory for further processing.

### Step 9:

Server performs image and text composition to create advertising composite content.

Server takes the selected advertising text and generated image as input and uses an image processing library to overlay the text onto the image.

Server computes a text bounding box based on the display format's text_position_region and automatically adjusts font size and line breaks to avoid overflow.

Server applies anti-aliasing and color contrast adjustments to maintain legibility.

Server outputs a final composite image file that combines the advertising text and the advertising image in compliance with the predetermined advertising medium specification.

### Step 10:

Server stores prompt sentences, generated content, and metadata in storage.

Server takes the first prompt sentence, the second prompt sentence, the advertising text message, and the composite image as input.

Server assigns identifiers, creates relational links between prompts and outputs, and writes records into database tables (for example, prompt table, text table, image table, creative table).

Server also stores a reference to the associated product and campaign.

Server outputs persistent records that can be retrieved for later editing, analysis, and distribution.

### Step 11:

Server transmits the advertising composite content to the terminal for user review and editing. Server selects appropriate image resolutions and encodes the composite image into a web-friendly format.

Server constructs a response message including the advertising text, image URL or binary, and relevant metadata (for example, character count, channel).

Server outputs this response message via the network, and terminal receives it as input.

Terminal decodes the response, renders the preview on the display, and provides UI controls for editing text or requesting regeneration.

### Step 12:

User reviews and optionally edits the generated advertising content on the terminal.

User observes the previewed composite content and decides whether the message or visual should be changed.

User edits the text in an input field or selects alternative variations if presented.

Terminal captures the edited text and selected options as input, packages them into an update request, and outputs the update request back to the server.

### Step 13:

Server updates the stored advertising composite content based on user edits.

Server receives the edited text and creative identifier as input and validates the edited content against length and safety rules.

Server replaces the old text field in the creative record with the edited text, marks versioning information, and, if necessary, regenerates the composite image to reflect text layout changes. Server outputs an updated creative record and, optionally, sends the updated preview to the terminal.

### Step 14:

Server executes an advertisement distribution process using the stored advertising composite content.

Server takes as input the final creative identifiers and distribution parameters (for example, channels, budget, schedule) supplied previously or configured by default.

Server formats the composite content according to each external distribution device's API specification and sends the creative data and parameters to those devices.

External distribution devices distribute the advertisements to end users, and server receives as output result information such as impression counts, click counts, and conversion events.

### Step 15:

Server calculates response indexes and performs feedback analysis.

Server takes result information and associated creative and prompt identifiers as input.

Server computes response indexes, such as click-through rate and conversion rate, and normalizes them across different channels.

Server correlates these indexes with prompt features and generation parameters and updates prompt generation conditions and model call conditions using a learning algorithm (for example, parameter adjustment rules or a simple gradient-free optimizer).

Server outputs updated configuration parameters that influence future prompt generation and generative AI model invocations.

### Step 16:

Terminal and user state acquisition devices provide user state information for dynamic adaptation. Terminal captures sensor data such as facial images and voice samples and sends extracted feature vectors to a user state acquisition engine.

The engine outputs emotion state information (for example, joy, sadness, anxiety) and behavior history information (for example, recent interactions with ads).

Terminal or the user state acquisition device transmits this user state information to the server as input for real-time adaptation.

### Step 17:

Server uses user state information to dynamically change prompt sentences and regenerate content. Server takes as input the current user state information and existing prompt sentences or advertising text.

Server adjusts the role, tone, and constraint segments of the first prompt sentence and, optionally, of the second prompt sentence according to mappings between emotions and desired message styles. For example, when the user state indicates anxiety, server generates the prompt sentence:
“The user feels anxious about choosing a smartphone.
Product: SmartPhone X with a 108 MP camera and 24-hour battery.
Goal: reassure the user and reduce anxiety.
Generate a short, calm, and supportive ad message within 90 characters.”

Server calls the text generative AI model again with the modified prompt sentence, receives new advertising text information as output, and, if necessary, repeats image generation and composition. Server returns updated composite content to the terminal, enabling real-time adaptation of displayed advertising content.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

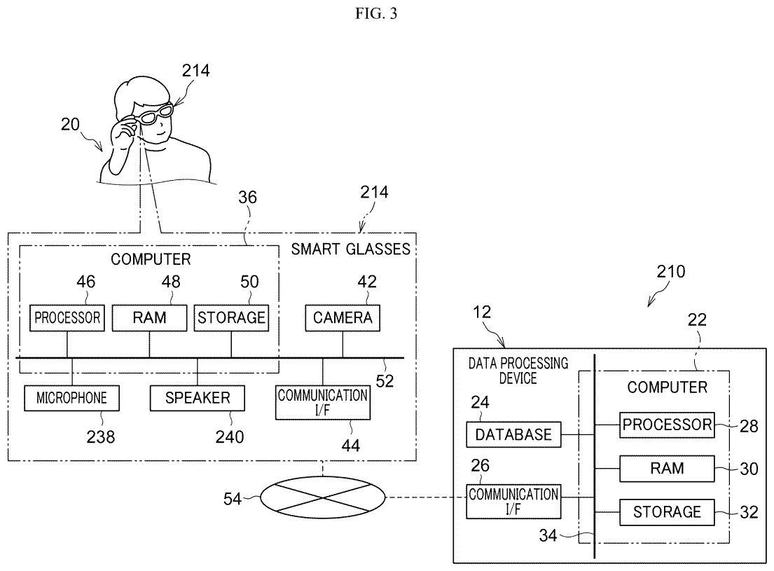

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

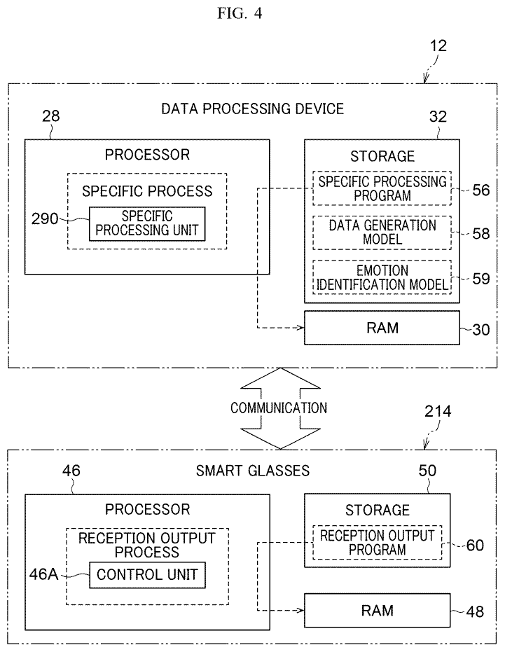

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent.

Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

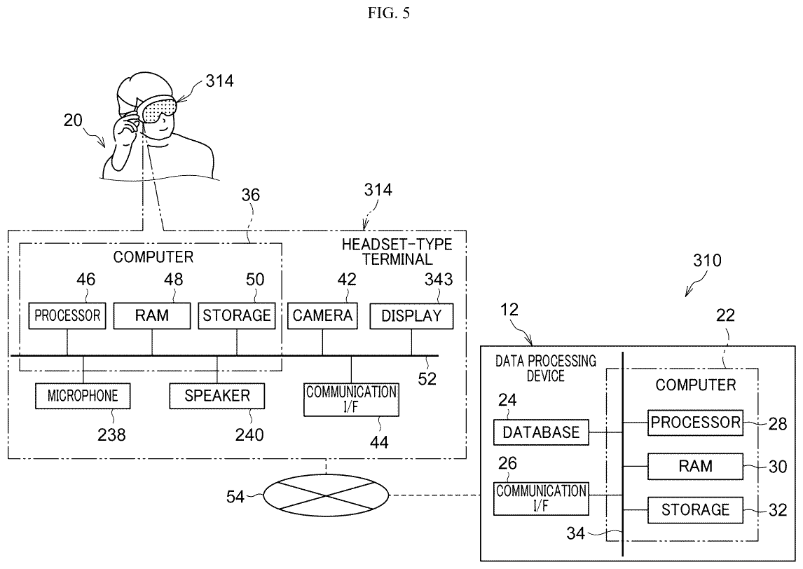

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

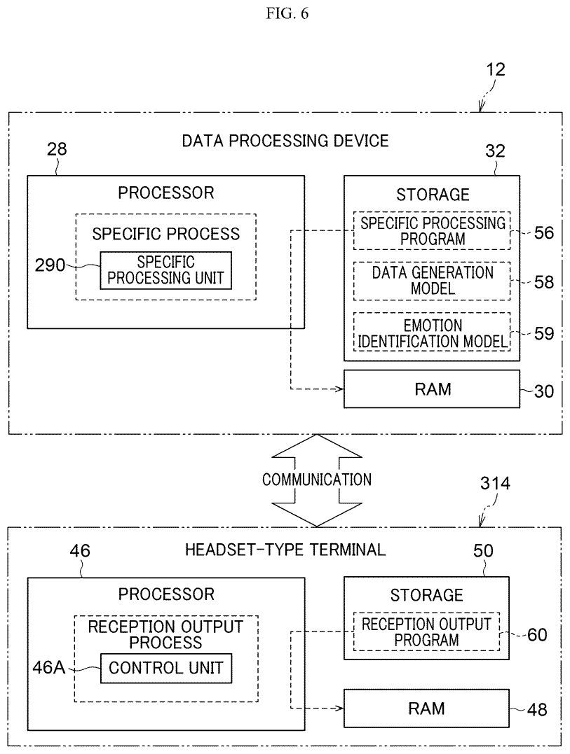

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

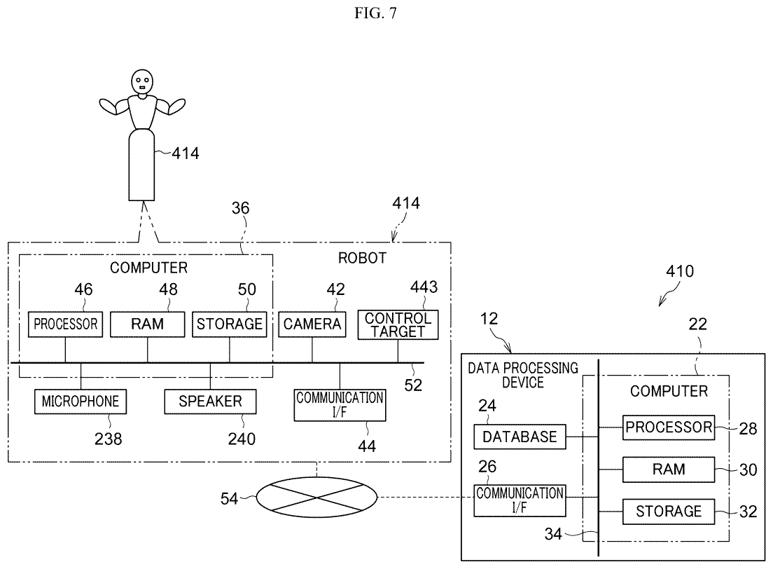

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

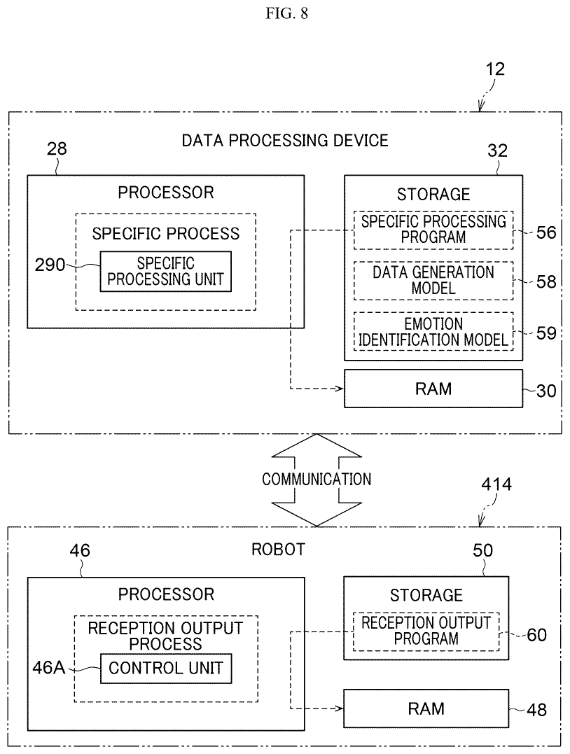

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

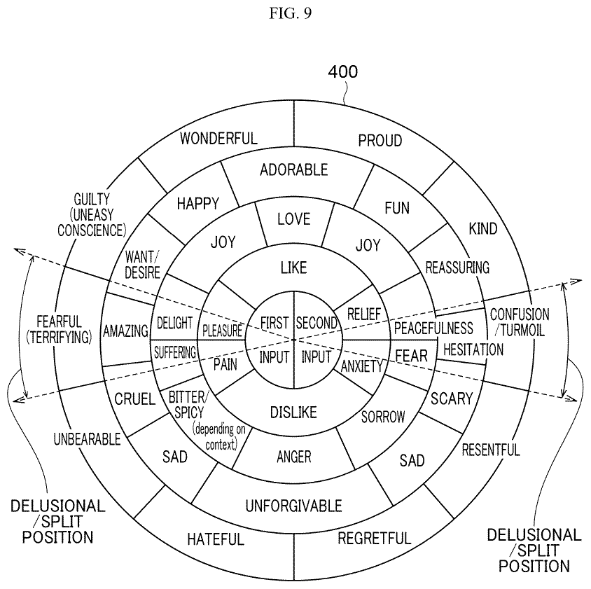

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

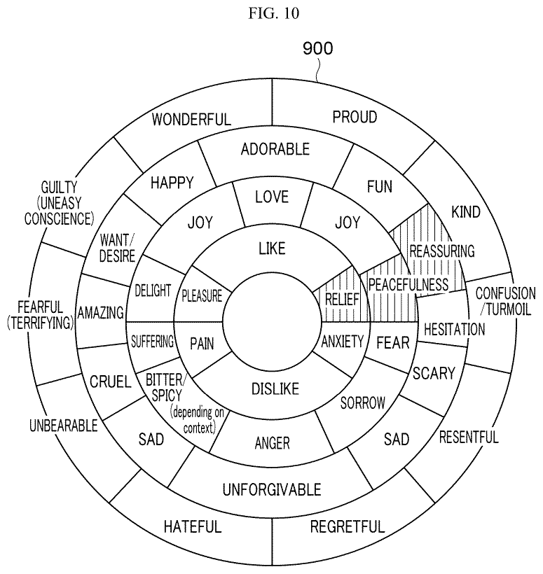

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor and a storage device,
wherein the processor is configured to
acquire, via a communication line from a user terminal, input data including attribute information relating to a product or service to be advertised, appeal information, and advertisement format information, validate the input data by checking for missing items, format conformity, and length, and perform text preprocessing including removal of unnecessary character strings and normalization of notation to thereby generate preprocessed structured data,
select, on the basis of the preprocessed structured data, at least one sentence generation pattern from among a plurality of predefined sentence generation patterns prepared in accordance with at least one of an advertisement format, an appeal item, a target attribute, and a style condition, and embed the structured data into the selected sentence generation pattern so as to automatically construct a prompt sentence suitable for input to a generative AI model and generate request data including the prompt sentence for the generative AI model,
transmit, via an external interface, the request data to the generative AI model, acquire from the generative AI model an advertisement message candidate generated on the basis of the prompt sentence, divide the advertisement message candidate into a plurality of advertisement messages according to at least one of line delimiters and numbering, and generate postprocessed advertisement messages by deleting, in accordance with a predetermined character-count constraint or expression constraint, an unnecessary portion from the plurality of advertisement messages,
store, in the storage device, the postprocessed advertisement messages in association with the prompt sentence used to generate the advertisement messages and the input data, and assign to stored records a unique identifier and state information, and
generate screen data of an advertisement management screen including a plurality of text input regions in which the postprocessed advertisement messages are individually editable and a list display of processing states from advertisement creation through submission, transmit the screen data to the user terminal, and, on the basis of editing results received via the advertisement management screen from the user terminal, update corresponding advertisement messages and the state information in the storage device.

### Supplementary 2

The system according to supplementary 1,
wherein the processor is configured to
hold, as the plurality of sentence generation patterns, a plurality of template groups selectable on the basis of at least one of advertisement format, medium type, maximum output character count, number of outputs, tone type, and target segment type, and automatically narrow down the template groups in accordance with the advertisement format information and target segment information included in the input data and generate the prompt sentence, thereby enabling generation of the advertisement messages with a reduced number of input items in operation by a small or medium-sized business operator.

### Supplementary 3

The system according to supplementary 1,
wherein the processor is configured to
perform an evaluation process by calculating at least one of a click rate, a conversion rate, a revenue index, and a delivery volume index on the basis of the advertisement messages stored in the storage device and distribution result data associated with the advertisement messages, analyze a relationship between the evaluation result and each of the prompt sentence and the input data, generate feedback information indicating effectiveness of combinations of appeal items, expression formats, and advertisement formats, cause the feedback information to be displayable on the advertisement management screen, and reflect the feedback information in at least one of selection conditions of the sentence generation patterns and generation conditions of the prompt sentence.

### Application Example 1

### Supplementary 1

A system comprising a processor,
wherein the processor is configured to
receive input information including advertisement target information, appeal information, and advertisement format information acquired from a user terminal,
preprocess the input information by normalizing the information as character information, including unifying encoding formats, removing unnecessary characters, and converting the advertisement format information into an internal identifier,
construct, on the basis of the preprocessed input information, a prompt sentence described in a natural language including the advertisement target information, the appeal information, and the advertisement format information, and convert the prompt sentence into model input data for input to a generative AI model,
input the model input data to the generative AI model and cause the generative AI model to generate generated result data including an advertisement message and advertisement campaign configuration information,
decode and format the generated result data and edit the generated result data as structured advertisement information including headline information, body information, call-to-action information, and advertisement distribution meta information,
transmit the structured advertisement information to a user interface of the user terminal having an advertisement preview screen and an editing screen, and enable confirmation and editing by a user at the user terminal,
and receive edited advertisement information and approval information from the user terminal and store the edited advertisement information while centrally managing submission to an external advertisement distribution platform and distribution schedule setting via an advertisement distribution management screen.

### Supplementary 2

The system according to supplementary 1,
wherein the processor is configured to, in the preprocessing of the input information, store a plurality of types of advertisement template information associated with the advertisement format information, present the plurality of types of advertisement template information as selectable options on the user interface, and enable easy advertisement creation operations by a business entity having a small business scale.

### Supplementary 3

The system according to supplementary 1,
wherein the processor is configured to analyze performance indicators of the advertisement message on the basis of the generated result data and advertisement distribution performance information acquired from the external advertisement distribution platform, and generate improvement suggestion information according to an analysis result and present the improvement suggestion information to the user terminal so as to promote monetization and an increase in an amount of advertisement placement.

### Example 2

### Supplementary 1

A system comprising a processor,
wherein the processor is configured to
receive, from a terminal device, attribute information and advertisement condition information regarding an advertisement target item, analyze the attribute information and the advertisement condition information to extract characteristics and appeal elements of the advertisement target item, generate, based on an extraction result and the advertisement condition information, a prompt sentence for instructing a generative AI model to generate an advertisement text, input the prompt sentence into the generative AI model to cause the generative AI model to generate the advertisement text, and transmit the generated advertisement text to the terminal device so that display and editing of the advertisement text are executable on the terminal device,
obtain, based on the advertisement condition information, a character-count constraint and a component-structure constraint corresponding to an advertisement format, and adjust a length and a structure of the prompt sentence and the generated advertisement text so as to satisfy the character-count constraint and the component-structure constraint,
generate, based on the characteristics and the appeal elements of the advertisement target item, an image-generation prompt sentence for input to an image-generative AI model, cause the image-generative AI model to generate advertisement image data based on the image-generation prompt sentence, and associate the advertisement text and the advertisement image data with one another to form an advertisement creative, and
manage the advertisement text and the advertisement image data in an integrated manner, and provide, to the terminal device, advertisement management screen data that enables execution of a submission process for transmitting the advertisement creative to an external distribution platform.

### Supplementary 2

The system according to supplementary 1,
wherein the processor is configured to
present, based on advertisement format information acquired from the terminal device, a plurality of types of advertisement template information, and provide, to the terminal device, user interface data that allows a user including a small-scale business operator to selectively generate the advertisement text and the advertisement image data using the plurality of types of advertisement template information.

### Supplementary 3

The system according to supplementary 1,
wherein the processor is configured to
acquire advertisement delivery result information from the external distribution platform, calculate an effectiveness index of the advertisement creative based on the advertisement delivery result information, and generate feedback information that is presented to the terminal device and that includes an improvement proposal for the prompt sentence and for settings of the advertisement condition information in accordance with the effectiveness index.

### Application Example 2

### Supplementary 1

A system comprising a processor,
wherein the processor is configured to
receive, from a user device, attribute information of an advertising target, appeal conditions, and display format information, and convert the attribute information and the appeal conditions into structured data,
generate, based on the structured data and the display format information, a first prompt sentence including a character length constraint and an expression condition, and cause an external generative AI model to generate advertising text information by inputting the first prompt sentence into the external generative AI model,
generate, based on the advertising text information and the attribute information, a second prompt sentence including a visual expression condition, and cause an external image generative AI model to generate advertising image information by inputting the second prompt sentence into the external image generative AI model,
perform text processing and image processing on the advertising text information and the advertising image information to generate advertising composite content conforming to a predetermined advertising medium specification, transmit the advertising composite content to the user device, and update the advertising composite content in accordance with edit content received from the user device,
store, in a storage device, the advertising composite content in association with the first prompt sentence and the second prompt sentence, transmit the advertising composite content to an external distribution device to execute an advertisement distribution process, and acquire result information of the advertisement distribution process and accumulate the result information as analysis target data, and
dynamically change at least one of the first prompt sentence, the second prompt sentence, and the advertising text information based on user state information including at least one of emotion state information and behavior history information acquired from a user state acquisition device, and call the external generative AI model again to generate, in real time, advertising text information or advertising composite content optimized in accordance with the user state information.

### Supplementary 2

The system according to supplementary 1,
wherein the processor is configured to execute an interface process in which the processor provides, to the user device, a plurality of template information items having different configuration elements, layouts, and expression tones of the advertising composite content, and automatically sets generation conditions of the first prompt sentence, the second prompt sentence, and the advertising composite content in accordance with a selection result of the template information, thereby enabling completion of an advertisement creation process with a reduced number of user operations.

### Supplementary 3

The system according to supplementary 1,
wherein the processor is configured to calculate a response index for each of the first prompt sentence, the advertising text information, and the advertising image information based on the result information of the advertisement distribution process, update, in a learning manner, prompt generation conditions and call conditions of the external generative AI model in accordance with the response index, and present, to the user device, evaluation information including at least an advertisement improvement policy and a recommended setting.

What is claimed is:

1. A system comprising:
circuitry configured to:
acquire, via a packet-switched network from a terminal apparatus, input data including attribute information relating to a target item, emphasis information, and output format information;
validate the input data by checking for missing items, format conformity, and length constraints, and perform text preprocessing including removal of unnecessary character strings and notation normalization to generate preprocessed structured data;
select at least one sentence generation pattern from a plurality of predefined sentence generation patterns based on the preprocessed structured data, and embed the preprocessed structured data into the selected sentence generation pattern to construct a parameterized instruction sequence for a generative neural network model;
provide the parameterized instruction sequence to the generative neural network model to cause the generative neural network model to generate descriptive content data; and
perform postprocessing on the descriptive content data including segmentation according to delimiter patterns and enforcement of character-count constraints to generate postprocessed content data, and transmit the postprocessed content data to the terminal apparatus via the packet-switched network.

2. The system according to claim 1, wherein the circuitry is further configured to:
store the postprocessed content data in a storage medium in association with the parameterized instruction sequence and the input data, and assign to each stored record a unique identifier and state information indicating a processing stage.

3. The system according to claim 2, wherein the circuitry is further configured to:
generate interface data including a plurality of editable text regions in which the postprocessed content data items are individually modifiable, and transmit the interface data to the terminal apparatus for display on a presentation interface.

4. The system according to claim 3, wherein the circuitry is further configured to:
receive editing result data from the terminal apparatus via the interface data, and update corresponding content data records and state information in the storage medium based on the editing result data.

5. The system according to claim 1, wherein the plurality of predefined sentence generation patterns are organized into template groups selectable based on at least one of the output format information, a medium type specification, a maximum output character count, a number of output items, a tone type specification, and a target segment type specification.

6. The system according to claim 5, wherein the circuitry automatically narrows the template groups based on the output format information and target segment information included in the input data, and constructs the parameterized instruction sequence using the narrowed template group, thereby reducing the number of input parameters required from the entity.

7. The system according to claim 1, wherein the circuitry is further configured to:
acquire distribution result data associated with the postprocessed content data from an external distribution system via the packet-switched network, and compute effectiveness metric values including at least one of an engagement rate value, a conversion rate value, a performance index value, and a distribution volume index value based on the distribution result data.

8. The system according to claim 7, wherein the circuitry is further configured to:
analyze a relationship between the effectiveness metric values and each of the parameterized instruction sequence and the input data, and generate feedback data indicating effectiveness of combinations of emphasis information, expression formats, and output formats.

9. The system according to claim 8, wherein the circuitry is further configured to:
reflect the feedback data in at least one of selection conditions of the sentence generation patterns and content of the parameterized instruction sequence for subsequent content generation, thereby implementing an iterative optimization loop.

10. The system according to claim 9, wherein the circuitry is further configured to:
transmit the feedback data to the terminal apparatus for display on the presentation interface, enabling the entity to review effectiveness trends and adjust input parameters accordingly.

11. The system according to claim 1, wherein the generative neural network model comprises a transformer-based architecture including an embedding layer, a plurality of self-attention layers, feed-forward layers, and normalization layers, and wherein the circuitry provides the parameterized instruction sequence as a token sequence to the transformer-based architecture together with decoding control parameters including a maximum output token count and a sampling temperature value.

12. The system according to claim 11, wherein the parameterized instruction sequence includes a style specification directive and a tone specification directive that constrain the generative neural network model to generate descriptive content data conforming to predetermined stylistic and tonal parameters.

13. The system according to claim 1, wherein the circuitry is further configured to:
generate a plurality of variant descriptive content data items by providing the parameterized instruction sequence with variation parameters specifying different emphasis orderings and expression styles, and present the plurality of variant items to the terminal apparatus for entity selection.

14. The system according to claim 13, wherein the circuitry is further configured to:
compute comparative effectiveness predictions for each variant descriptive content data item by applying a trained prediction model to feature vectors derived from the variant items and historical effectiveness metric data, and rank the variant items by predicted effectiveness.

15. The system according to claim 14, wherein the trained prediction model comprises a neural network having an input layer corresponding to dimensions of the feature vectors, one or more hidden layers with non-linear activation functions, and an output layer that computes predicted effectiveness scores.

16. The system according to claim 1, wherein the circuitry is further configured to:
acquire image data associated with the target item from the terminal apparatus, apply an image analysis model to the image data to extract visual attribute data including color distribution values, object category labels, and composition feature values, and incorporate the visual attribute data into the parameterized instruction sequence.

17. The system according to claim 16, wherein the image analysis model comprises a convolutional neural network having a plurality of convolutional layers, pooling layers, and fully connected layers trained to extract visual feature representations from image data.

18. A system comprising:
circuitry configured to:
acquire, via a communication interface coupled to a packet-switched network, input data from a terminal apparatus including attribute information, emphasis information, and output format information;
validate and preprocess the input data to generate preprocessed structured data;
select a sentence generation pattern from predefined patterns based on the preprocessed structured data, and construct a parameterized instruction sequence by embedding the preprocessed structured data into the selected pattern;
provide the parameterized instruction sequence to a generative neural network model having a transformer-based architecture including a plurality of self-attention layers to generate descriptive content data;
perform postprocessing on the descriptive content data including segmentation and character-count enforcement to generate postprocessed content data;
store the postprocessed content data with the parameterized instruction sequence and input data in a storage medium; and
acquire distribution result data, compute effectiveness metric values, generate feedback data, and reflect the feedback data in subsequent parameterized instruction sequence construction.

19. The system according to claim 18, wherein the circuitry is further configured to:
generate a plurality of variant content data items with different emphasis orderings, compute predicted effectiveness scores for each variant using a trained prediction model, and rank the variants for entity selection.

20. A method performed by circuitry, the method comprising:
acquiring, via a packet-switched network from a terminal apparatus, input data including attribute information relating to a target item, emphasis information, and output format information;
validating the input data and performing text preprocessing to generate preprocessed structured data;
selecting at least one sentence generation pattern from a plurality of predefined sentence generation patterns based on the preprocessed structured data, and embedding the preprocessed structured data into the selected sentence generation pattern to construct a parameterized instruction sequence for a generative neural network model;
providing the parameterized instruction sequence to the generative neural network model to cause the generative neural network model to generate descriptive content data; and
performing postprocessing on the descriptive content data including segmentation and character-count enforcement to generate postprocessed content data, and transmitting the postprocessed content data to the terminal apparatus via the packet-switched network.
